(19) United States
(12) Patent Application Publication
(10) Pub. No.: US 2011/0125783 A1
(43) Pub. Date: May 26, 2011

(54) APPARATUS AND METHOD OF ADAPTIVE QUESTIONING AND RECOMMENDING

(76) Inventors: Peter WHALE, Witchford (GB); Stephen STATLER, San Diego, CA (US); Hugh O'DONOGHUE, Dun Laoghaire (IE); Isobel DEMANGEAT, Eye (GB); Andrew PEGUM, Dublin (IE); Sean CORRIGAN, Enfield (IE)

(21) Appl. No.: 12/948,751

(22) Filed: Nov. 17, 2010

Related U.S. Application Data
(60) Provisional application No. 61/262,748, filed on Nov. 19, 2009.

(51) Int. Cl. G06F 17/30

(52) U.S. Cl. 707/769; 707/E17.014

(57) ABSTRACT

By adaptive questioning in a way that is entertaining, recommendations can be presented to a subscriber even with a limited amount of user profile information. Moreover, the questioning can allow a subscriber to learn something about himself. Each interaction can be short as well as light hearted and fun in order to accommodate intermittent usage with frequent interruptions. Intermixing questions/recommendation selections that are focused on gaining profile information as well as being somewhat random can unexpectedly learn something about the subscriber while keeping the user experience entertaining. Personal details can be avoided and tools for editing stored personal information can enhance a sense of privacy in order to induce trust. Questions and other responses can lead to other questions in a manner that allows characterizing a subscriber so that recommended offerings can be selected that are appropriate.

### CLAIM OF PRIORITY UNDER 35 U.S.C. §119

The present application for patent claims priority to Provisional Application No. 61/262,748 entitled “APPARATUS AND METHOD OF ADAPTIVE QUESTIONING AND RECOMMENDING” filed Nov. 16, 2010, and assigned to the assignee hereof and hereby expressly incorporated by reference herein.

### BACKGROUND

The present disclosure relates to a mobile operating environment, and more particularly to providing improved methods of generating questions and recommendations to users of a mobile device.

Mobile operators or mobile device carriers play a major part in the telecommunication industry today. Initially, such mobile operators concentrated their efforts on generating revenue by increasing their subscriber base. However, it will be appreciated that in several countries, the scope for increasing the subscriber base has now become very limited, as the market has reached close to saturation point. As a result, the mobile operators have been branching into providing value added services to subscribers, in order to increase their revenue.

One means of generating increased revenue is through the sales of premium services to users, such as ringtones, wallpaper, games, etc. These services may be provided by the mobile operator themselves, or by business entities such as mobile device manufacturers or media brands who may operate in collaboration with the mobile operators or independently, leveraging the carrier's network, to provide such services. The services may be available for download to a mobile device upon payment of a fee.

Many benefits, such as maximizing the potential earnings for sales, accrue upon recommending and promoting content or services that are the most likely to be of interest to the users. Further, the user can have a better experience using the user's mobile device in light of these individually recommended content and services, or independently, leveraging the carrier's network.

However, providing helpful suggestions to a user of a mobile device can be thwarted by a lack of information about the user, the user's demographics, likes, and dislikes. Mitigating this issue is made more challenging by the anonymous nature of pre-paid calling plans where registering of subscriber information such as name and address is not required and in the use of family plans where a number of users with different phones may share a single subscription. As another example, a user can make a limited number of purchases or interactions from which to derive recommendations for future transactions. As an additional aspect, soliciting user inputs to improve recommendations can prove tedious or intrusive to some users, who thus would refuse to participate.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with learning about a user of a device, such as a wireless mobile device, in a way that is entertaining, by querying and offering content both known and not known to be of interest.

In one aspect, a method is provided for recommending content to a user by employing a processor executing computer executable instructions stored on a computer readable storage medium to implement the following acts: A set of interaction queries is accessed. Each query can be associated with a decision association and a presentation instruction. An interaction query is presented via a mobile user interface in accordance with the presentation instruction. A first characteristic of a user of the mobile user interface is determined based upon a response to the interaction query. A plurality of content objects is presented for user interaction comprising a first object that is selected to correspond to the first characteristic and a second object that is selected to solicit information regarding a second characteristic. The second characteristic comprises a desired characteristic to be known about the user.

In another aspect, a computer program product is provided for recommending content to a user. At least one computer readable storage medium stores computer executable instructions that, when executed by at least one processor, implement components: At least one instruction executable by the processor accesses a set of interaction queries, each query associated with a decision association and a presentation instruction. At least one instruction executable by the processor presents an interaction query via a mobile user interface in accordance with the presentation instruction. At least one instruction executable by the processor determines a first characteristic of a user of the mobile user interface based upon a response to the interaction query. At least one instruction executable by the processor presents a plurality of content objects for user interaction comprising a first object that is selected to correspond to the first characteristic and a second object that is selected to solicit information regarding a second characteristic. The second characteristic comprises a desired characteristic to be known about the user.

In an additional aspect, an apparatus is provided for recommending content to a user. At least one computer readable storage medium stores computer executable instructions that, when executed by at least one processor, implement components: Means are provided for accessing a set of interaction queries, each query associated with a decision association and a presentation instruction. Means are provided for presenting an interaction query via a mobile user interface in accordance with the presentation instruction. Means are provided for determining a first characteristic of a user of the mobile user interface based upon a response to the interaction query. Means are provided for presenting a plurality of content objects for user interaction comprising a first object that is selected to correspond to the first characteristic and second object that is selected to solicit information regarding a second characteristic. The second characteristic comprises a desired characteristic to be known about the user.

In a further aspect, an apparatus is provided for recommending content to a user. A computing platform accesses a set of interaction queries, each query associated with a decision association and a presentation instruction. A user interface presents an interaction query in accordance with the presentation instruction. The computing platform further determines a first characteristic of a user of the mobile user interface based upon a response to the interaction query. The user interface further presents a plurality of content objects for user interaction comprising a first object that is selected to correspond to the first characteristic and a second object that is selected to solicit information regarding a second characteristic. The second characteristic comprises a desired characteristic to be known about the user.

In yet one aspect, a method is provided for recommending content to a user by employing a processor executing computer executable instructions stored on a computer readable storage medium to implement the following acts: A mobile device is provisioned with a set of interaction queries, each query associated with a decision association and a presentation instruction. A report is received from the mobile device that indicates a user input to the at least one of the set of interaction queries that was presented in accordance with the presentation instruction. A first characteristic of a user of the mobile user interface is determined based upon a response to the interaction query. A user profile is updated based upon the first characteristic. A plurality of content objects is transmitted to the mobile device for user interaction comprising a first object that is selected to correspond to the first characteristic and a second object that is selected to solicit information regarding a second characteristic. The second characteristic comprises a desired characteristic to be known about the user.

In yet another aspect, a computer program product is provided for recommending content to a user. At least one computer readable storage medium stores computer executable instructions that, when executed by at least one processor, implement components: At least one instruction executable by the processor provisions a mobile device with a set of interaction queries, each query associated with a decision association and a presentation instruction. At least one instruction executable by the processor receives a report from the mobile device that indicates a user input to the at least one of the set of interaction queries that was presented in accordance with the presentation instruction. At least one instruction executable by the processor determines a first characteristic of a user of the mobile user interface based upon a response to the interaction query. At least one instruction executable by the processor updates a user profile based upon the first characteristic. At least one instruction executable by the processor transmits a plurality of content objects to the mobile device for user interaction comprising a first object that is selected to correspond to the first characteristic and a second object that is selected to solicit information regarding a second characteristic. The second characteristic comprises a desired characteristic to be known about the user.

In yet an additional aspect, an apparatus is provided for recommending content to a user. At least one computer readable storage medium stores computer executable instructions that, when executed by the at least one processor, implement components: Means are provided for provisioning a mobile device with a set of interaction queries, each query associated with a decision association and a presentation instruction. Means are provided for receiving a report from the mobile device that indicates a user input to the at least one of the set of interaction queries that was presented in accordance with the presentation instruction. Means are provided for determining a first characteristic of a user of the mobile user interface based upon a response to the interaction query. Means are provided for updating a user profile based upon the first characteristic. Means are provided for transmitting a plurality of content objects to the mobile device for user interaction comprising a first object that is selected to correspond to the first characteristic and a second object that is selected to solicit information regarding a second characteristic. The second characteristic comprises a desired characteristic to be known about the user.

In yet a further aspect, an apparatus is provided for recommending content to a user. A transmitter provisions a mobile device with a set of interaction queries, each query associated with a decision association and a presentation instruction. A receiver receives a report from the mobile device that indicates a user input to the at least one of the set of interaction queries that was presented in accordance with the presentation instruction. A computing platform determines a first characteristic of a user of the mobile user interface based upon a response to the interaction query and updates a user profile based upon the first characteristic. The transmitter further transmits a plurality of content objects to the mobile device for user interaction comprising a first object that is selected to correspond to the first characteristic and a second object that is selected to solicit information regarding a second characteristic. The second characteristic comprises a desired characteristic to be known about the user.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram of an aspect of a system having an adaptive questioning engine and a recommendation engine for interacting with a user or subscriber;

FIG. 2 is a flow diagram of an aspect of a method of adaptive questioning and/or making recommendations;

FIG. 3 is a schematic diagram of an aspect of a communication network that employs a distributed architecture with a recommendation engine that supports a client;

FIG. 4 is a flow diagram of an aspect of a method determining a next question to be asked in an aspect of the system of FIG. 1;

FIG. 5 is a schematic diagram of an aspect of a user profile for use in an aspect of the system of FIG. 1;

FIG. 6 is a schematic diagram of an aspect of a weighted list of attributes for use in an aspect of the system of FIG. 1;

FIG. 7 is a schematic diagram of an aspect of a question for use in an aspect of the system of FIG. 1;

FIG. 8 is a schematic diagram of an aspect of one or more user-specific ranked questions for use in an aspect of the system of FIG. 1;

FIG. 9 is a flow diagram of an aspect of a methodology or sequence of operations performed by a server back end;

FIG. 10 is a flow diagram of an aspect of a methodology or sequence of operations performed by a server front end;

FIG. 11 is a flow diagram of an aspect of a methodology or sequence of operations performed by a client device;

FIG. 12 is a graphical depiction of an aspect of a user interface presenting a quiz;

FIG. 13 is a graphical depiction of an aspect of a user interface presenting a user profile and other utilities;

FIG. 14 is a graphical depiction of an aspect of a user interface presenting recommendations in an entertaining manner;

FIG. 15 is a graphical depiction of an aspect of a user interface presenting recommendations in another entertaining manner;

FIG. 16 is a graphical depiction of an aspect of a user interface presenting recommendations in an additional entertaining manner;

FIG. 17 is a flow diagram of an aspect of a method of adaptive questioning and recommending;

FIG. 18 is a graphical depiction of an aspect of a home page user interface for use in an aspect of an adaptive questioning and recommending system;

FIG. 19 is a graphical depiction of an aspect of a recommendation listing user interface for use in an aspect of an adaptive questioning and recommending system;

FIG. 20 is a graphical depiction of an aspect of a random recommendation listing user interface for use in an aspect of an adaptive questioning and recommending system;

FIG. 21 is a graphical depiction of an aspect of a recommended item detail user interface for use in an aspect of an adaptive questioning and recommending system;

FIG. 22 is a graphical depiction of an aspect of a quiz user interface for use in an aspect of an adaptive questioning and recommending system;

FIG. 23 is a graphical depiction of an aspect of a quiz results user interface for use in an aspect of an adaptive questioning and recommending system;

FIG. 24 is a graphical depiction of an aspect of a quiz results comparison user interface for use in an aspect of an adaptive questioning and recommending system;

FIG. 25 is a graphical depiction of another aspect of a question results comparison user interface for use in an aspect of an adaptive questioning and recommending system;

FIG. 26 is a graphical depiction of an aspect of a user profile user interface for use in an aspect of an adaptive questioning and recommending system;

FIG. 27 is a graphical depiction of an aspect of an identified interests listing user interface for use in an aspect of an adaptive questioning and recommending system;

FIG. 28 is a schematic diagram of an aspect of an exemplary environment for adaptive questioning and recommending;

FIG. 29 is a schematic diagram of an aspect of a distributed wireless communication system for a recommendation engine to support a client mobile device;

FIG. 30 is a schematic diagram of an aspect of a recommendation network having interactions between certain components associated with a mobile operator and a profile and recommendation system;

FIG. 31 is a schematic diagram of an aspect of a system or apparatus for adaptive questioning and recommending; and

FIG. 32 is a schematic diagram of another aspect of a system or apparatus for adaptive questioning and recommending.

### DETAILED DESCRIPTION

Adaptive questioning and recommendation engines can enhance a user experience with a mobile device while creating opportunities for additional revenue for carriers by quickly characterizing a user in an entertaining way. In one or more aspects, opportunities for interaction via queries (e.g., a set of questions intended to solicit user characterizations) are associated (e.g., via metadata) with a manner of presenting the query to the user (e.g., quiz, like-don't like selection games, etc.). In addition, in one or more aspects, an explicit or implicit response from the user can be used in accordance with further decision-based metadata for the query to select additional queries, as well as to generate recommendations (e.g. of content).

In an exemplary aspect, a shopping assistant program can get to know a user by a combination of self-characterizing responses to a sequence of questions presented to the user, and by inferred characterizations learned by what objects are selected, discarded, ranked by the user, etc. For example, in some aspects, items that are responsive to a user's expressed needs are presented along with items that may or may not meet a user's implicit or explicit preferences. Based on how the user responds, the shopping assistant program can determine further characterizations of the user for use in determining future recommendations.

As another example, a real estate program can gather basic information from a user regarding price range, location and housing requirements. Then, by showing a range of houses, the real estate program is enabled to better characterize the user, especially ascertaining those preferences that the user was unable or unwilling to articulate.

As yet an additional example, consider an advisor or recommender program advising a user as to what video to watch, audio to listen to, text to read, etc. For example, without the advisor or recommender program, the range of offerings can be daunting, especially in an on-demand environment. By presenting some combination of questions and presenting recommendations or questions designed to discover user attributes inside and slightly outside a known or inferred comfort zone (e.g. area of interest) of a user, the program arrives at an intelligent recommendation, even without the user being consciously aware of the user's predispositions or interests.

Such focused adaptive questioning and recommendation assistance can be particularly helpful when presenting content offerings by a mobile interface limited in its bandwidth and presentation capabilities. For example, shopping by a mobile device can be more akin to looking at a store front window rather than being able to browse through aisle upon aisle of goods and services. As such, one or more of the described aspects provide a question pattern or sequence designed to elicit predetermined information from a user, as well as to engage the user. The question pattern may initially be based on historical user responses to the same or similar questions, and may be configured to obtain a certain mixture of information gathering and user entertainment. Further, in some cases, the described aspects may include a questioning engine that updates a user profile, and that may in real-time adapt a next question or the entire question pattern as a result of each user response in order to further characterize or engage the user. Additionally, based on the ever increasing data being added to the user profile via the answers from the user to specific questions, a recommendation engine can operate to provide personalized recommendations to the user, which may vary based on a user's context (e.g. a specific type of recommender program, such as a shopping program versus a program dealing with entertainment options, a location of the user, etc.). Thus, the described apparatus and methods of adaptive questioning and/or recommending gain knowledge of a user and/or provide recommendations personalized to the user.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects

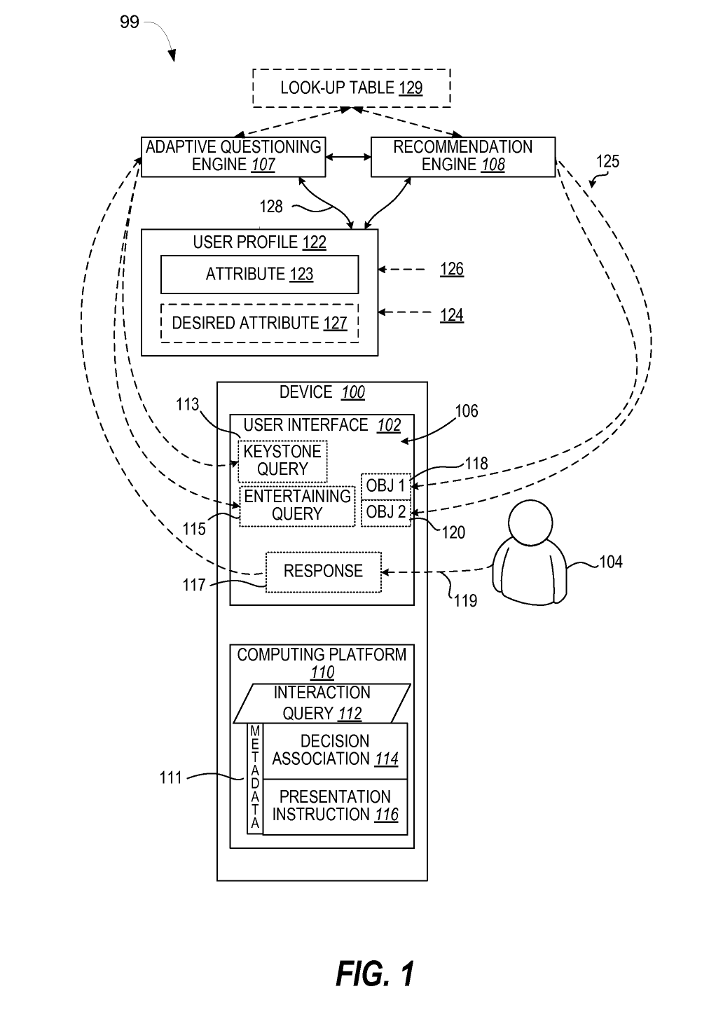

Referring to FIG. 1, a system 99 for adaptive questioning and recommending includes a device 100 that presents one or more user interfaces 102 for a user 104 to experience content 106. An adaptive questioning engine 107, which may be located locally, remotely or in a distributed architecture, interacts with a computing platform 110 to enhance the user experience by providing entertaining interaction via the user interface 102 whereby the user 104 can be characterized. For instance the user 104 can be a new user for whom no demographic, behavioral, preference or interest data, or transaction histories are available. At another extreme, the user 104 can be well characterized; yet a continuing need exists to update this characterization to detect the user's 104 evolving tastes and life situations as well as to perhaps open new areas unfamiliar to the user 104. Data that can characterize the user, such as via one or more user attributes 123, can include data that defines marketing-related, demographic-related, etc. interests or descriptions of the user, and such data may be referred to herein as “keystone” data 126. In an aspect, one or more attributes 123 may be stored in a user profile 122 associated with the user. Moreover, in pursuing such “keystone” data 126 to support a comprehensive characterization of a user, in an aspect, adaptive questioning engine 107 can provide unrelated diversions, e.g. question not related to keystone data, interspersed in a set of queries or interaction questions 112 designed to elicit keystone data 126 in order to enhance the user experience. As such, the adaptive questioning engine 107 may generate a set of interaction queries 112, also herein referred to as a question pattern, which are queries configured to obtain keystone data 126 as well as to engage the user, e.g. via one or more entertaining queries 115, and elicit further interaction so that further characterizations may be obtained or inferred. System 99 can thereby build a user profile 122 for user 104, where the user profile includes one or more attributes 123, which may include or be derived from keystone data 126, for example, obtained in a response 117 to one or more of the set of interaction queries 112. Based upon characterizations of user 104 according to one or more attributes 123 in user profile 122, a recommendation engine 108, which may be located locally, remotely, or in a distributed architecture, executes a method for recommending content and thereby can generate one or more recommendations 125, e.g. relating to goods or services, such as content, for presentation to the user 104. In an aspect, for example, a purchase by the user of a good or service based on the one or more recommendations 125 may increase revenue opportunities for a wireless carrier using the present system as well as may meet the needs of the user 104 for a desired good or service, such as content. In addition, in some aspects, adaptive questioning engine 107 gauges how the user 104 interacts with the recommendations 125, e.g. makes a purchase, makes further inquires, or disregards, in order to provide a basis for updating one or more attributes 123 and for further questioning and recommending.

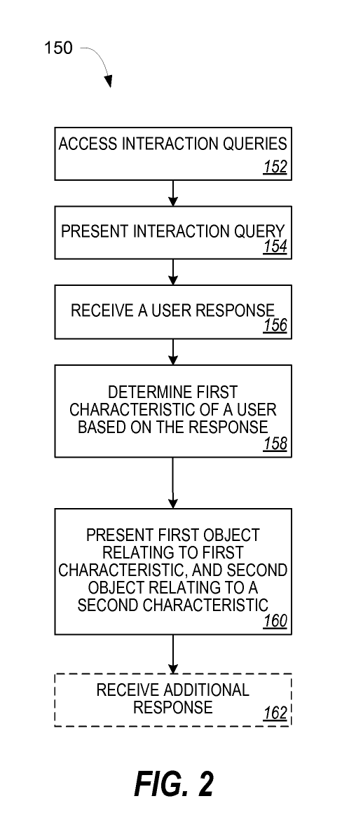

To that end, and additionally referring to a method 150 of recommending content in FIG. 2, according to one aspect, the computing platform 110 accesses the set of interaction queries 112 (FIG. 2, Block 152). For example, in an aspect, the set of interaction queries 112 includes at least one keystone query 113 and at least one entertaining query 115, where the set of interaction queries 112 is designed to enable determination of at least one keystone data 126 for use in defining one or more user attributes 123. In a given set of interaction queries 112, any number of approaches could be adopted to determine the mix of keystone queries 113 and entertaining queries 115, including but not limited to a random mix, a predetermined sequence (e.g., ask a keystone query after every 3 entertaining queries), using an adaptive rate for asking keystone (or interactive) queries, e.g. where the rate adapts based on how eager or not eager an individual user is perceived to be to provide keystone data 126. For example, for someone who is very comfortable sharing lots of information, the described aspects may have a high frequency of keystone queries, versus a lower frequency for a more reserved user, where the described aspects may pose a keystone query only occasionally. Moreover, each query 112 may be associated with metadata 111, including but not limited to a decision association 114 and a presentation instruction 116. For example, in an aspect, decision association 114 may include, but is not limited to, data such as: one or more of keystone data 126, or attributes 123 that enable characterizing the user based on the response 117 received from the user; linking data that links to one or more other queries that may be presented to the user based on response 117 to the current query, any other data relating to another query to ask a user, a user profile attribute to discover, or a content item to recommend to the user. Further, for example, in an aspect, presentation instruction 116 may include, but is not limited to, one or more instructions or data relating to how to present the corresponding query to the user, including presentation styles such as “yes” or “no” options, multiple options, sorting, ranking, game-style selection, etc. As such, the user interface 102 presents one or more interaction queries 112 in accordance with the corresponding presentation instruction 116, and receives at least one corresponding response 117 or answer, e.g., based on a user input 119 (FIG. 2, Blocks 154 and 156). The adaptive questioning engine 107 and/or recommendation engine 108 further determines a first characteristic (e.g., sports fan), e.g. attribute 123, of the user 104 based upon at least one response to at least one interaction query 112, or a plurality of the queries (FIG. 2, Block 158). The user interface 102 further presents a plurality of content objects for further user interaction, such as a first object 118 that is selected to correspond to the first user characteristic (e.g., a basketball pay-per-view ticket corresponding to attribute 123 that defines the user as a sports fan) and a second object 120 that is selected to solicit information regarding a second user characteristic, such as a desired-to-know user attribute 127 (e.g., a music download for a particular musical group) (FIG. 2, Block 160). The second user characteristic, as may be defined by the desired-to-know user attribute 127, may include, for example, data that further defines the already-known attribute 123, such as a particular sport for which the user is a sports fan, or data that defines a new interest, or lack thereof, or new keystone data 126 describing the user. For example, in an aspect, adaptive questioning engine 107 and/or recommendation engine 108 may select one of the set of interaction queries 112 that correlates to a likelihood of obtaining data on the second user characteristic or desired-to-know user attribute 127. Further, in an alternative or additional example, adaptive questioning engine 107 and/or recommendation engine 108 may select one of the set of interaction queries 112 according to relevance. For instance, given that the described aspects know that a user likes sports involving competitive teams, the described aspects may determine (via heuristics, decision algorithms, operator input, etc.) that it may be relevant to find out whether the user likes attending live games or prefers watching the games on television, even though it may be a higher priority to find out whether the user prefers, for example, Jazz or Rock type music. Optionally, one or more additional responses may be received from the user in response to the plurality of presented objects (FIG. 2, Block 162). For example, the one or more responses may include receiving one of an explicit affirmation or an explicit discarding input for the second object, e.g. which may indicate an interest or lack of interest, respectively, corresponding to the second object, or which may include a preference input of the first object relative to the second object, or vice versa.

As such, user profile 122 may be populated with a growing amount of data, such as one or more attributes 123 based on responses 117 or direct user input 124. For example, in some aspects, one or more attributes 123 may include, or be derived from: keystone data 126 included in one or more responses 117, or included in direct user input 124, or both; inferences 128 based on one or more responses 117, or included in direct user input 124, or both. Additional interaction queries 112 can be selected that are associated with the user profile 122, to the extent that it exists, and from decision associations 114 for previously presented interaction queries 112. Moreover, as noted, entertaining queries 115 can also be interspersed among keystone queries 113 in the set of interaction queries 112 provisioned for the device 100 to enhance the user experience, such as to entertain or engage the user in an effort to maintain subsequent user interaction with the queries.

The queries 112 can be inherently inter-related such that different responses prompt different subsequent queries. Alternatively, a change in a focus of the queries 112 can occur in batches, for example, when such determinations are made remotely in order to avoid taxing the computational throughout and power supply of the device 100 in the case of a distributed system architecture.

The queries 112 can be in the form of a recommended good or service, e.g. recommendation 125 may be considered a type of interaction query 112. Alternatively, the responses 117 to the queries 112 can lead to periodically presenting a recommendation 125, e.g. a good or service. In some aspects, interaction queries 112 or recommendations 125 may be generated for presentation on device 100 when a new opportunity is detected by recommendation engine 108. For example, if recommendation engine 108 obtains information that ticket sales for a concert are announced, then recommendation engine 108 may recommend the concert to any user having a user profile 122 having at least one attribute 123 that correlates with an interest in the concert. In other words, recommendation engine 108 may subsequently present a third object based upon a first and/or second characteristic, such as a user attribute in a user profile, in response to determining a new availability of the third object, e.g. the ticket for the concert. Alternatively or in addition, the user 104 can request queries 112 or recommendations 125. Alternatively or in addition, an input can be received from the user 104 that identifies a certain interval of receiving queries 112 or recommendations 125, e.g. a user specified time interval such as a “weekly recommendation,’ thereby enabling recommendation engine 108 to sustain interaction with the user over long time periods.

In an aspect, adaptive questioning engine 107 and/or recommendation engine 108 may operate with very few or no attributes 123 in user profile 122, e.g. even without initial demographic, preference, browsing, preview or rating data for the user 104. This may be referred to as a cold start problem. In these aspects, adaptive questioning engine 107 and recommendation engine 108 may include a lookup table 129, which may include historical data on questions and how other users of system 99 have responded to such questions, thereby enabling adaptive questioning engine 107 and/or recommendation engine 108 to determine which questions work well and which questions work less well across an aggregate population of users. In other words, lookup table 129 correlates a plurality of available interaction queries to interaction query response data from a plurality of user profiles. Based on such information, for example, adaptive questioning engine 107 and/or recommendation engine 108 may select questions that have historically worked well for the set of interactive queries 112 for use with a new user. Alternatively, or in addition, questions for the set of interactive queries 112 for use with a new user may include open ended questions, which allow the user to identify one or more attributes 123, the response 117 to these questions then being used to select further questions or recommendations determined to be of interest to the user.

Further, in some aspects, adaptive questioning engine 107 and/or recommendation engine 108 may operate even if particular content items for recommending, e.g. recommendations 125, are not well described by meta-data. For example, adaptive questioning engine 107 and/or recommendation engine 108 may draw inferences from historical data, e.g. from look-up table 129, that define the types of users that have previously selected or shown interest in the recommendation 125.

Further, adaptive questioning engine 107 can configure the set of interaction queries 112 to define an engaging conversation or a quick personality quiz, and operate in conjunction with recommendation engine 108 in presenting recommendations 125, thereby eliciting the user 104 to volunteer more and more information. Additionally, adaptive questioning engine 107 can utilize real-time feedback of user responses 117 to queries 112 or recommendations 125 to adapt subsequent queries to be of more interest to the user, or to discover new user attributes 123. Moreover, the apparatus and method of system 99 may be positioned on device 100 for easy discoverability and use (e.g., as a web-based tool, a pre-installed application, a user interface on a home screen, in a “recommended for you” category, etc.).

In an exemplary aspect, the adaptive questioning engine 107 provides dynamic and flexible mechanism to create interactive question and answer sequences. For instance, each interaction query 112 may include one or more information formats, such as one or more of text, graphics, or audio. Individual queries 112 can be skipped, which can provide an inference 128 in itself. Accordingly, in an aspect, adaptive questioning engine 107 may select a next question based at least in part upon response 117, including an answer or a non-answer, to a preceding question. For instance, if user 104 indicates that they user prefers sports, the next question could narrow down whether the user 104 is a spectator or active player for various kinds of sports. Further, as previously mentioned, recommendations 125 can be posed as interaction queries 112. In some aspects, attributes 123 or keystone data 126 (e.g., age, gender), may be directly asked or input by the user. Moreover, in some aspects, location information can be taken into account for subsequent queries or recommendations. Also, in some aspects, recent inputs or local information on user interactions on device 100 can be given consideration in formulating interaction queries 112 and/or recommendations 125. Additionally, in some aspects, user 104 can be afforded an opportunity to delete locally stored inputs or interactions, or user profile data, as part of privacy management and to enhance user trust and openness.

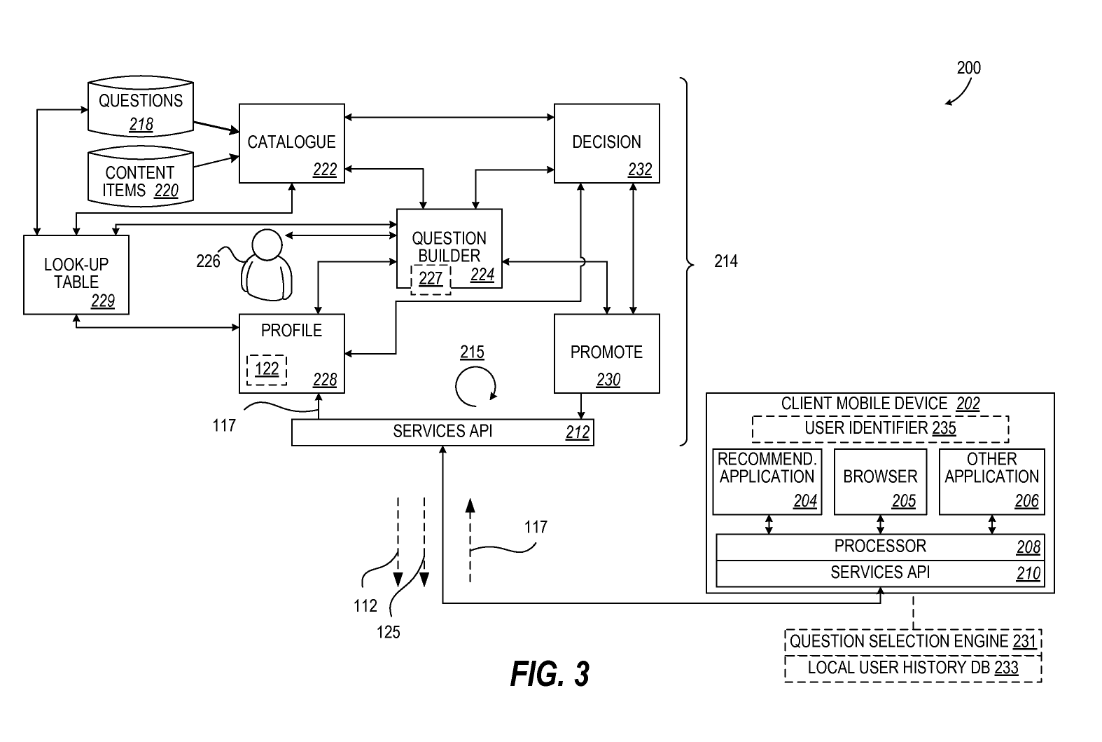

Referring to FIG. 3, in one aspect of a possible implementation of adaptive questioning engine 107 and recommendation engine 108 of FIG. 1, a communication system 200 can employ a distributed architecture for providing adaptive questioning and recommendations generated through entertaining questions. At least a portion of the adaptive questioning and recommendation capability may be provided in a recommendation application 204, which may be implemented through one or more of a dedicated application, a browser 205, or another application 206, any or all of which can run on a processor 208 that is interfaced via a services Application Programming Interface (API) 210 to a front end of question and recommendation system 214, which includes a web services API 212.

A back-end of question and recommendation system 214 draws upon a questions repository 218, which stores questions, and content items repository 220, which stores content items, in order to populate a catalogue 222. The mobile device 202 receives recommendations 125, receives one or more questions or quizzes or items to rate, etc., such as interaction queries 112, from the front end 212 and returns responses 117 or answers (e.g., express or implicit, binary or quantitative, etc.) for real-time feedback 215.

A question builder component 224 retrieves and updates questions and content items from the catalogue 222, and interacts with and provides support tools for a question designer 226 to create questions/quizzes, e.g. interaction queries 112. In one aspect, question builder component 224 may include a conversational scripting tool 227 that can be used to create questions with rich metadata 111, and to create interaction queries 112 having question sequences or optional progressions, including alternative questions or question types to pose subsequently, depending on the response 117 or answer received to the current interaction query 112 or question 218.

For instance, in addition to creating a flow of interactions between system 214 and a user, the conversational scripting tool 227 can provide a flexible linkage, rather than a fixed sequence, between questions 218 in the set of interaction queries 112. Thus, the linkage between one question 218 and the next question 218 is much more fluid and dynamic (e.g., if the answer is “yes” to “Do you like console games?” then questions are selected that explore games genres in more detail) as compared to a fixed, non-adaptive sequence. The linkage can be loosened, though, to intersperse off-base or diversionary questions, such as entertaining queries 115 (FIG. 1), to avoid sounding like an interrogation. Further, conversational scripting tool 227 can enable automated question sequence selection at least in some instances.

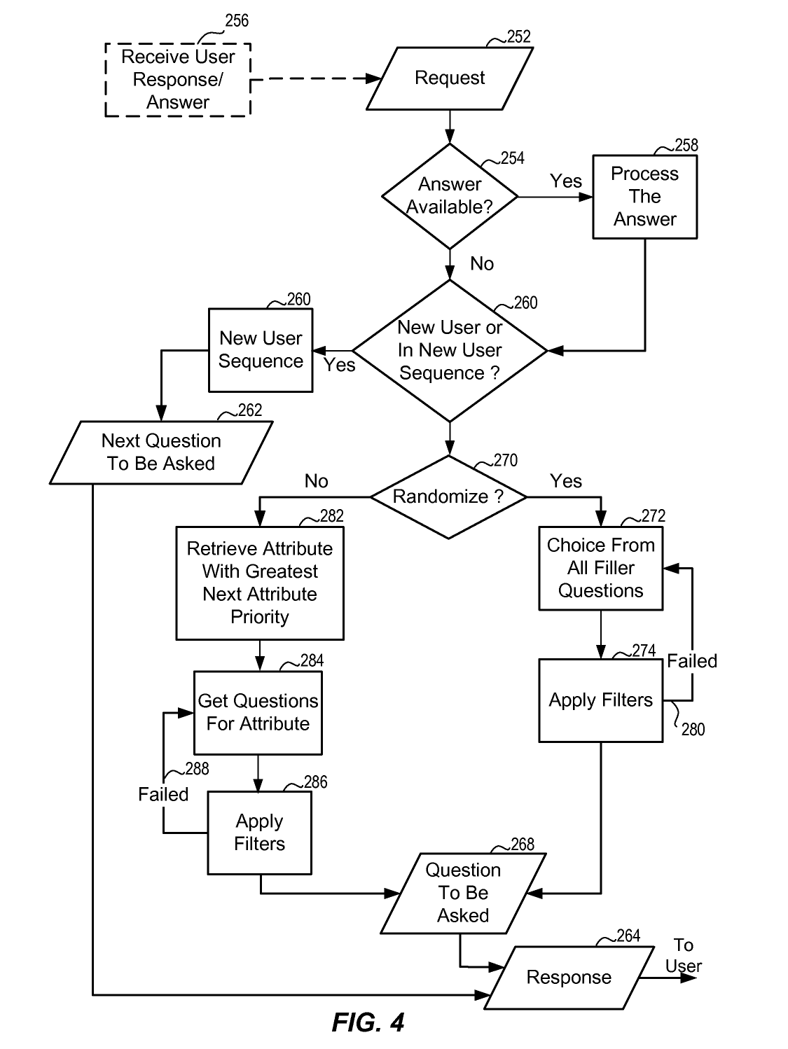

Referring to FIG. 4, for example, in one aspect a method 250 of dynamic, adaptive questioning includes receiving a request for a question (Block 252). For example, the request for the question may be received from client mobile device 202 (FIG. 3) at recommendation engine 214 (FIG. 3), such as at question builder component 224 (FIG. 3).

The method 250 may further include determining if an answer is available (Block 254). For example, the request for a question (Block 252) may be based on receiving one or more answers corresponding to a prior question (Block 256). If so, then method 250 proceeds to process the answer (Block 258). For example, in an aspect, processing the answer may include, but is not limited to, one or more of: updating a user profile based on the information in the prior question and its various answers; updating a group profile associated with the user profile; obtaining new recommendations based on the updated user profile attributes; updating a user history of questions asked and/or answered; or updating a history of question sequence information. In other words, with regard to updating the user profile, if a user answers in a certain way, a certain learning is made about the user, which may be expressed in terms of changes, positive or negative, to a value of one or more attributes defining the user in the user profile. With regard to updating the profile group, this may include updating one or more groups that define a set of similar people all sharing certain attributes, attribute values, or ranges thereof.

After processing the answer (Block 258), or if no answer is available, e.g., the request is a first time user request or a request unrelated to a prior question, then method 250 proceeds to determining if the user is a new user or if the user is in a new user sequence (Block 260). For example, the described aspects may include a set of questions to be presented to a new user, such as questions designed to obtain a base set of information from the new user. As such, if the user is a new user or if the user is in the middle of the set of questions to be presented to a new user, then method 250 includes accessing a new user sequence of questions (Block 262), e.g. the new user set of questions, determining a next question to be asked (Block 264), and transmitting a response, including the next question to be asked, to the requesting device (Block 266), e.g. the client mobile device 202 (FIG. 2). For example, in an aspect, after accessing the new user sequence of questions, the determining of the next question to be asked (Block 264) may include selecting a next question in a sequence of questions, based on a last question for which an answer was received, such as in the case of the sequence of questions having a relative order between each question. In another aspect, the determining of the next question to be asked (Block 264) may include randomly selecting a next question in the sequence of questions. In any case, in this manner, the present apparatus and methods provide a new user sequence of questions to a new user in order to build a user profile for the user.

On the other hand, if the method 250 determines that the user is not a new user or if the user is not in a new user sequence, then method 250 may include determining a question to be asked (Block 268), which may be a random question or a question selected based on a priority, and transmitting a response, including the question to be asked, to the requesting device (Block 266), e.g. the client mobile device 202 (FIG. 2). For example, in an aspect, method 250 may include determining whether or not a next question should be chosen randomly (Block 270).

If method 250 determines that the next question should be randomly chosen, then method 250 includes choosing a question from a plurality of all questions (Block 272), and applying one or more filters to the chosen question (Block 274) in order to determine the question to be asked (Block 268). For example, in an aspect, the plurality of all questions may include keystone queries 112 (FIG. 1) and entertaining questions 130 (FIG. 1), which may also be referred to as filler questions that are designed more for fun than for learning something new about the user. In other words, the entertaining questions 130 (FIG. 1) may be used to break up the very pointed and earnest keystone queries 112 (FIG. 1) with some fun questions. Further, for example, the applying of the one or more filters to the chosen question (Block 274) may include applying one or more filters, such as but not limited to, a filter such as: a question skipped filter, which determines if a question has been previously skipped, where an operator of the present apparatus and methods may then set the filter to allow the question to be asked again, or to select a new question; an entry criteria filter, which determines if the user has interests or characterizations, such as based on already acquired keystone data or demographic information, that correspond to the question, e.g. “this question can be asked of people with a high value in a certain attribute,” or, e.g. a question designed for a male may not be appropriate to pose to a female; or a question already answered filter, which determines of the chosen question has already been answered, and if so, may then re-direct the method to select a new question; a categorization filter, which determines a categorization filter, which determines if the next question should be picked from one of a set of pre-determined categories, e.g. “the next question selected should be from one of the categories of Music, Games or Entertainment”, such categorization filter permitting a variety of questions from a range of categories to be selected over time. For example, in some aspects, this portion of the method may access a history of questions asked, a history of answers received, or other historical information relating to the questions and answers in order to determine a result of applying a filter. Additionally, as noted, method 250 may include determining a failure when applying the filter (Block 280), e.g. the chosen question has already been answered, and then proceeding to choose another question (Block 272), which may repeat until a chosen question passes the filter and is determined to be the question to be asked (Block 268).

If method 250 determines that the next question should not be randomly chosen, then method 250 includes retrieving an attribute with a greatest next attribute priority (Block 282).

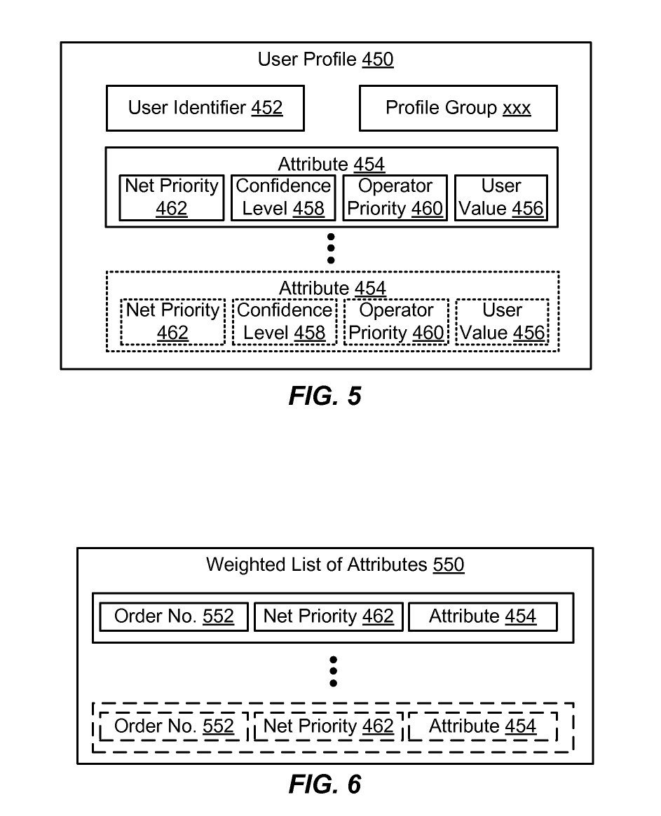

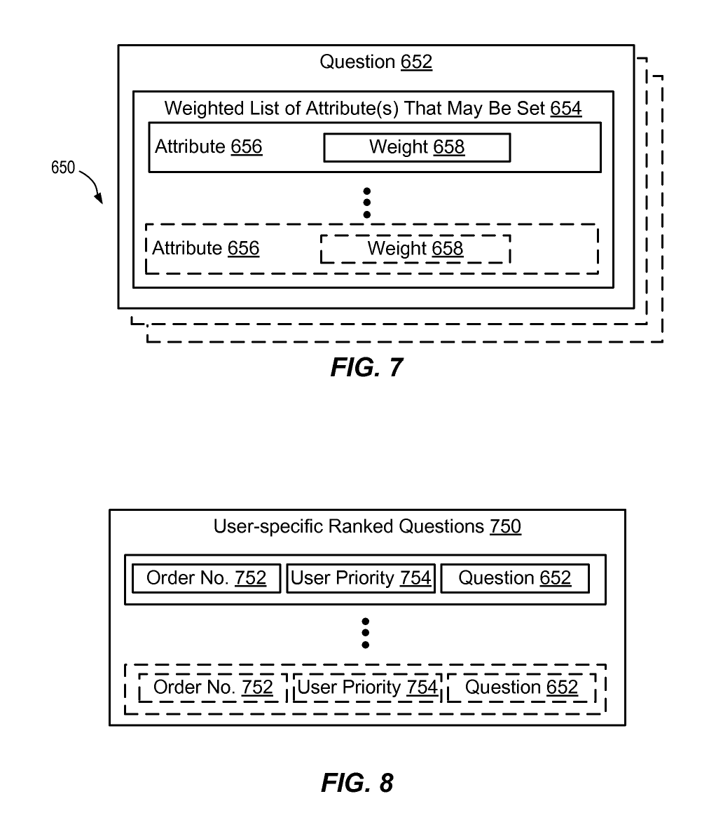

For example, referring to FIG. 5, in an aspect, each user profile 450 includes a user identifier 452, which indicates a name or code for the user, and a collection of attributes 454 that define characteristics or interests of the user. For example, each attribute 454 may have a user value 456 that indicates, for example, a level of user interest in the attribute or a level of correspondence between the user and the attribute, e.g. a measure of how well the attribute defines the user. The user value 456 may be user-defined, system-defined (e.g. based on inferences or suppositions drawn from user answers to questions), or some combination of both. Moreover, in some optional aspects, each attribute 454 may further include a variable confidence level 458, which may define a level of confidence in the user value 456. For example, confidence level 458 may have a first value if a user responds to a question with an answer that clearly defines a level of interest in or characterization relative to the attribute, and a second value if the user value is based on inference or supposition, where the first value indicates a greater level of confidence than the second value. Further, in some optional aspects, each attribute 454 may have a priority assigned by an operator of the described apparatus and methods, e.g. an operator priority 460, where the operator priority 460 indicates an importance to the operator of finding out information about that attribute from the user. In another optional aspect, the operator priority 460 and the respective confidence level 458 associated with the confidence the operator has in the user value 456 for the respective attribute 454 may be combined or applied to a function, for example a weighting algorithm, to create a net priority 462 for each attribute 454 for the user. For example, a relatively high confidence level 458 in any one attribute 454 can reduce the operator priority 460 for that attribute 454, as the relatively high confidence level 458 represents having learned something about that user. Accordingly, in one aspect, additionally referring to FIG. 6, the retrieving of the attribute with the greatest next attribute priority (Block 282) may include generating a weighted list of attributes 550, e.g. weighted or having an order number 552 based on a relative value of the net priority 462 of each attribute 454, and selecting a highest priority attribute from the weighted list of attributes 550. Thus, for example, one result may be a weighted list where having a high confidence in an attribute with a relatively high operator priority attribute may make the attribute drop below another attribute having a relatively low operator priority and a relatively low, or no, value for the confidence level. It should be noted, however, that any number of different results may be obtained depending on how the weighting algorithm is implemented, which may vary from one operator to another.

Additionally, after the retrieving of the attribute with the greatest next attribute priority (Block 282), method 250 may further include obtaining one or more questions for the identified attribute (Block 284). For example, in one aspect, and additionally referring to FIG. 6, the obtaining of the one or more questions for the identified attribute may include analyzing a plurality of questions 650 to create, for each question 652, a weighted list of attributes 654 that may be set by the question. The plurality of questions 650 may be all possible questions, or some subset thereof. Further, the weighted list of attributes 654 that may be set by the question are attributes 656 that an answer to the question is likely to define, and the weight 658 of each attribute 654 relates to a level of characterization of that attribute 654 that an answer to the question 652 is likely to define. It is noted that each attribute 656 may be the same as, or additions to, the attributes 454 (FIG. 5) already associated with user profile 450 (FIG. 5) of the user. Further, for example, a question 652 may be all about sports, and thus the described aspects may provide a relatively high value for a weight 658 of a sports attribute 656 for the question 652. On the other hand, the question 652 may also have a minor reference to movie tastes, and so the described aspects may provide a relatively low value for a weight 658 of a movie taste attribute 656 for the question 652. It is noted that in the phrase “weighted list of attributes that may be set by the question,” the terminology of “may set” relates to the actual learning about a user that depends on the answer they give, e.g. one answer may have the “movie” reference, but another answer may not provide any learning of movie knowledge. Accordingly, in one aspect, and additionally referring to FIG. 8, the obtaining of the one or more questions for the identified attribute may include comparing the weighted (via net priority 462) attributes 454 of the user profile 450 and the weighted (via attributes 656 that may be set) questions 652 to rank the questions 652 in an order of priority for the user, e.g. a list of user-specific ranked questions 750 with each question 652 ordered based on a order value 752 that corresponds to a user priority 754 based on the comparing of the weighted attributes 454 of the user profile 450 and the weighted questions 652. For instance, in one example, the question 652 having a highest weight for an attribute to be set, where that attribute has the highest net priority, is ranked highest. In other words, in this aspect, the questions are ordered based on how much each question may learn for each attribute based on the net priority of each attribute.

Further, returning to FIG. 3, after obtaining one or more questions for the attribute (Block 284), method 250 may further include applying one or more filters to the one or more questions (Block 286) in order to determine the question to be asked (Block 268). The act of applying the one or more filters to the one or more questions (Block 286) may be similar to, or the same as, the applying of the one or more filters discussed above with regard to Block 274. Further, if a question fails to pass the application of a filter (Block 288), e.g. if the user profile does not include criteria for considering use of the question, then method 250 may return to obtaining the questions (Block 284) to select a next question in the list of user-specific ranked questions 750 (FIG. 8), which is a process that may repeat until a chosen question passes the filter and is determined to be the question to be asked (Block 268), which may then be provided in the response (Block 266).

Thus, in the above-described manner, a dynamically adapted new question designed to elicit information on one or more user attributes can be provided to a user of the present apparatus and methods.

Returning to FIG. 3, the question builder component 224 is also interfaced to a profile component 228 and a promote component 230, both of which are in turn interfaced to the services API 212 as well as a decision engine 232. The profile component 228 learns and retains information about each user, also referred to as a subscriber, based upon responses 117 or answers, settings, preferences, etc., received via the web services API 212. The promote component 230 designs question sequences and provides questions/quizzes and items to rate/answer/etc., e.g. interactive queries 112. The decision engine 232, which is also interfaced to the question builder component 224 and the catalogue 222, automatically decides on sequences of questions, e.g. interactive queries 112, for individual subscribers, and provides such sequences of questions to promote component 230 for proposing such questions to the subscriber.

The questions 218 that are generated can have rich metadata 111, both for those keystone queries 113 that provide rich profile information and for those fun, random, or intellectually-engaging questions, e.g. entertaining queries 113. The metadata 111 along with user profile 122, if available, can be used as a basis to select questions 218 or can be used in determining a way of presenting a question that is appropriate for a particular genre that could appeal to a user or subscriber (e.g., hip, off-beat, risqué, traditional, etc.). The questions 218 can be presented in a manner that conforms to available assets (e.g., graphics, text, audio) for the client device 202.

Each individual question 218 or each series of questions, e.g. interactive query 112, can be defined independently of one another. Question metadata 111 can allow the decision engine 232 to automatically create personalized question sequences, or interactive queries 112, and/or to suggest questions for a human to create a question sequence. The recommendation engine 214 can intelligently select a set of question sequences or interaction queries 112, or a sub-set of a question sequence, to download to the client device 202 and allow a high level of interactivity on the client device 202. In some aspects, the downloading may be optimized, perhaps in a block, for data/storage efficiency. Question/quiz metadata 111 can provide for how often to ask a keystone query 113, how many times to ask, and a list of keystone queries 113 for which to get an answer or response 117. The client device 202 can have a certain amount of autonomy, for example, to enhance responsiveness to the subscriber's recent activity and responses. In particular, in one aspect, the client device 202 may include a question selection engine 231 configured to select questions from those locally available, e.g. a downloaded set of interaction queries 112, that are deemed suitable, taking into consideration what the subscriber is currently doing (e.g., applications used, people called, ringtones selected, etc.), where the subscriber is, and what answers have been recently received, wherein such local user information may be stored in a local user history database 233. Thereby, an autonomous, local question selection engine 231 can increase responsiveness without burdening a transmission channel.

In an aspect, a user identifier 235 may be obtained by the server front end 212 and correlated to user profile 122 by the back end 216 so that user-specific questions can be generated at some point, enabling real time feedback 215. For example, user identifier 235 may include, but not limited to, a unique numerical ID can represent each individual user in all cases. For instance, user identifier 235 can be linked to, but may not be the same as, the mobile phone number or handset hardware ID number of the subscriber's device. For example, in some instances an individual may use a work cell phone in a different way from a wireless capable media player such that identification can further parse a particular persona of a single individual. Alternatively or in addition, more than one individual may use the same device. Alternatively or in addition, a temporary ID may be employed until the actual user is identified, which can enhance the likelihood of a user trying the service before committing to identify themselves. Alternatively or in addition, questioning and recommending system 214 can uniquely identify an individual for one or more devices or services available across a range of devices or services that can be accessed by the client device 202.

Additionally, in some aspects, question builder 224 may utilize a look-up table 229 that is created based on all available knowledge about questions and data from a population of user profiles, such as all user profiles, in order to determine the series of questions, e.g. interactive query 112, to ask a given user. The set of interactive queries 112 can vary depending on what is already known about the user as well as by the specific context of the user (e.g., a personal shopper context, a general “engagement” context, a first-time engagement context, etc.), which may be stored in or derived from information in the local user history database 233, and further based on what additional information can be obtained from the user through the interactive queries 112. In other aspects, look-up table 229 allows question and recommendation system 214 to interact with a user, even upon a “cold start,” e.g. without prior individual data for selecting questions and recommendations. For example, in an aspect, look-up table 229 may include historical data on questions and how other users of system 214 have responded to such questions, thereby enabling question and recommendation system 214 to determine which questions work well and which questions work not as well across an aggregate population of users. Based on such a determination, for example, question and recommendation system 214 may select questions that have historically worked well for the set of interactive queries 112 for use with a new user.

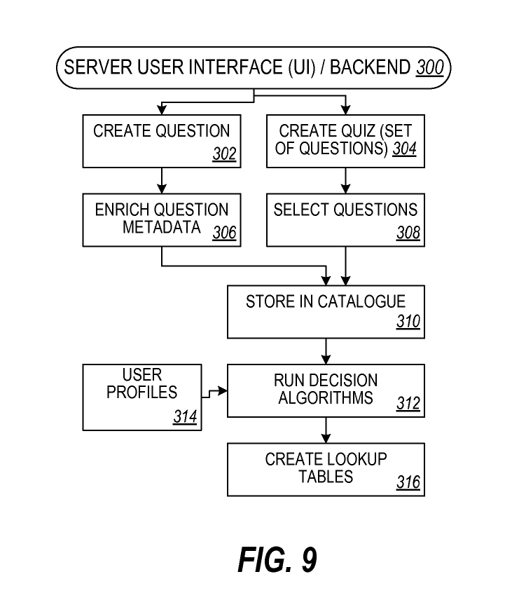

Referring to FIG. 9, a methodology or sequence of operations 300 performed by a server back end can include creating queries, depicted as creating a question (block 302) and creating a quiz (e.g., set of questions) (block 304). Respectively, the questions are enriched with metadata (block 306) and the quizzes can be enhanced by selecting questions (block 308). The created queries are stored in the catalogue (block 310). Decision algorithms are run (block 312), which may take into account one or more user profiles (block 314) in order to characterize each question or series of questions to thereby create lookup tables (block 316).

More specifically, the look-up tables are created based on running correlation algorithms over the questions from the catalogue combined with data from the user profiles in order to determine relationships. In other words, evaluations of the efficacy of certain questions can be determined based upon how other users have responded. To that end, the back end knows which questions other users have answered, how they have answered them, and how frequently each question has been asked, skipped, answered, how answered, etc. Based on this, the algorithms can determine which questions work well and which ones not as well across the aggregate population, or for a given situation or user. Questions likely to elicit predetermined user characteristics can thus be selected.

In some aspects, questions and question sequences can be human-generated, wherein these question sequences can be relied upon until an initial characterization of a user is obtained. In other aspects, the question generation is automated. In yet other aspects, the question generation is a combination of human-generated and automated.

In an additional aspect, the system could choose to ask questions on a wide variety of random topics, where such questions may be identified by being tagged as “open questions” which are designed to obtain high level information. For example, such open questions may relate to broad categories, and responses to these questions can lead to subsequent questions in narrower categories to identify a specific characteristic without prior starting information. An example includes asking “do you like playing sports?” If so, a variety of sports related questions can be asked. Otherwise, another broad category may be selected, such as “do you like the idea of listening to music tracks on your device?” or “do you enjoy playing console games?” Based on responses to these “open questions,” the system could select another set of questions which are more specific. The system is configured such that the manner in which these characterizations are arrived at is done in a somewhat unexpected, fun and random fashion to keep it light and entertaining.

Thus, in some instances, question selection and sequencing can be solely automated, based on the lookup tables, rather than relying upon human designs. For instance, the question selection can track which categorizations/characterizations have been recently confirmed for a user, returning to questions that pursue unknown attributes as a priority over confirming or refining an already known attribute.

Referring to FIG. 4, according to one aspect, a methodology or sequence of operations 400 performed by a server front end includes generating questions or quizzes in real time (block 402) as well as selecting pre-formed quizzes (block 404). These candidate questions/quizzes may be filtered (block 406), for example, based on information known about the user, the user context, or other network considerations. Optionally, the filtered set of questions may be encoded efficiently with regard to transmission bandwidth, desired latency limits, and other considerations (block 408). The filtered and/or encoded questions are transmitted to the client (block 410). Answers to previously deployed questions are received from the client (block 412). The user profile is augmented based upon the answers (block 414). The decision tables are updated in response to the answers (block 416). Thus updated, processing returns to block 402.

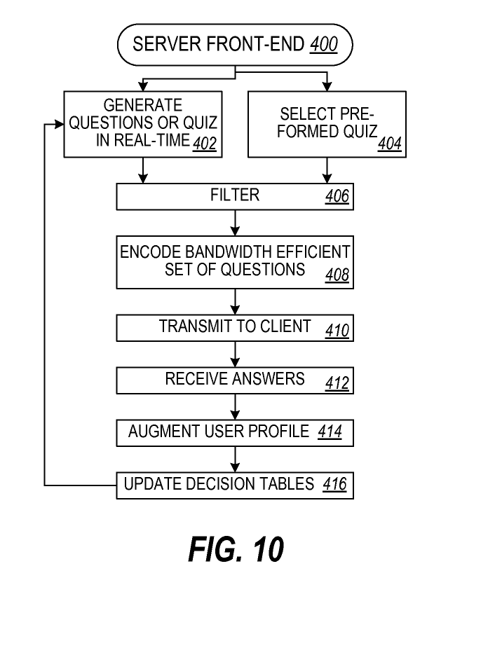

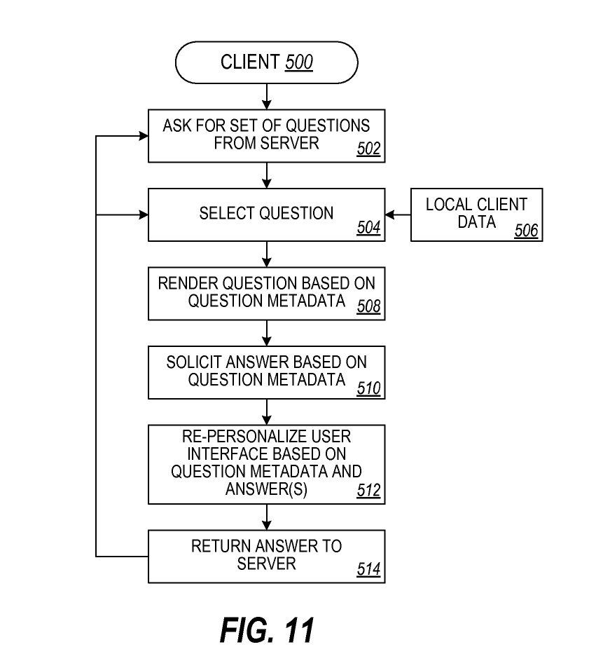

Referring to FIG. 10, according to one example, a methodology or sequence of operations for adaptive questioning and recommending 500 performed by the client can begin with asking for a set of questions from the server (block 502). One of the set of questions is selected (block 504), such as by a question selection engine. Optionally, the selection of the question may be based on local client data (block 506). For example, the question selection engine may further enhance and personalize the adaptive questioning process by taking into account data not known, i.e. the local data, when the initial set of questions was formulated. As such, the question selection engine may utilize similar algorithms as the system front end in order to further tailor the set of questions. Further, the questions are rendered in accordance with the associated metadata (block 508). Answers are solicited based upon the associated metadata (block 510). Optionally, in some aspects, the user interface can be re-personalized based upon the associated metadata and the answer(s) (block 512). In other words, the graphic or the language or style of questioning may change depending on the answers. The answers are returned to the server (block 514) and processing returns to either block 502 if more questions are needed or to block 504 if not.

By virtue of the foregoing, it should be appreciated that with the benefit of the present disclosure, a series of questions can be designed to engage the user, as well as to elicit predetermined information, e.g. “keystone” data, user “boundary” data (i.e., where is the user's comfort zone), etc. Building upon conversation scripting application (CSA), additional structure and an overall profiling objective is provided to the conversational questions. For example, one way to describe this might be to say that each series of questions has a desired question series “signature.” The signature can identify a profiling objective by representing a combination (or a range of combinations) of question metadata that define the series of questions. For example, a question series may have 1 to n questions, where n is a positive integer, and each question has a number of metadata that, in combination, define a respective question signature, and thus the sum of all of the question signatures in the series define the question series signature, as provided, for example, in Table 1:

TABLE 1
Question Series

Question 1: <question text, style, type, objective, links, assets, method,
other metadata . . . >
. . .
Question n: <question text, style, type, objective, links, assets, method,
other metadata . . . >
where:
“question text” is the actual wording of the question;
“style” is how the question is presented, including look/feel/manner of
soliciting the response . . . e.g., the “skins” or “vocabulary”;
“type” is keystone question, entertainment question, random question, or
boundary testing question;
“objective” is similar to type, but more specifically defines what is
wanted, e.g., user age, user sporting interest, user music genre, user
movie genre, etc., which can be more relevant to keystone or boundary
testing types of questions;
“links” are how this question relates to another question or to certain other
question parameters;
“assets” are graphics, audio clips, video clips, URLs, etc., for presentation
with the question; and
“method” includes how the question is asked, for example, multiple guess,
“select 1 answer out of N choices”, “answer Yes or No”, “answer
Sometimes, Always, Seldom, Never”, “Rank these items”, “answer
like or don't like”, “Answer with a text string”, etc.

With regard to rating-an-item type question, a question series can be designed to meet certain objectives, such as obtaining certain keystone data, engaging/entertaining the user, having a certain “flow,” having a certain “length,” etc. A question series meeting all of these objectives can be said to have a certain question series signature. This can also be referred to as a question pattern of the essential characteristics of the question sequence without the questions themselves. In another aspect, the signature can have defined metadata categories (e.g., style, type, objective, etc.). Optionally, or in addition, the metadata in a particular type of category, e.g. the series of “objective” metadata for each question in the series, may be configured in a particular pattern such that the series of category metadata (for one or more categories) can have its own category series signature.

Thus, in the server front end, and also at a client question selection engine, one goal is to create an initial or locally-modified set of questions that has a desired question series signature (or a signature that falls within a certain range). As such, various questions can be mixed and matched to produce the desired question series signature. Thus, using the user responses, the question series can be modified in real-time (or can be linked to or transformed into or replaced with another question series with a different signature to obtain additional information) to create an efficient data collection system that is also fun and engaging from a user perspective.

The apparatus and method of adaptive questioning and recommendation may be implemented in any number of user interfaces or programs. A number of sample use cases will now be discussed, however, many other use cases, user interfaces, or programs may incorporate the present teachings, and thus these examples should not be construed as limiting.

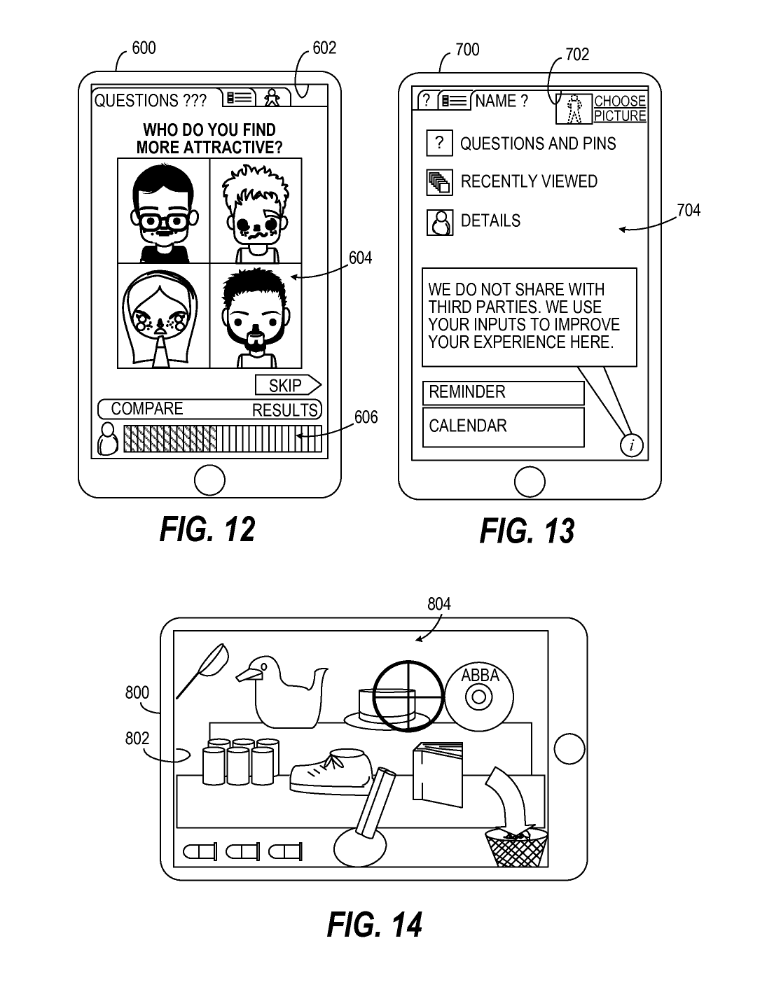

Referring to FIG. 12, for example, adaptive questioning and recommendation may be implemented in a selection-type program. A mobile device 600 has a graphical user interface 602 that is depicted as rendering a quiz 604 as to who is more attractive. Completing certain threshold numbers of quizzes can cause a lifeline 606 to fill progressively. For instance, a silver, gold, or platinum distinction can be earned by doing additional ratings in order to earn extra privileges and priority items. Characterization of the user can be gleaned from whether a particular selection was skipped or who was selected. For instance, a user can be identified as associating with a particular age or fashion demographic. In some aspects, for example, quiz answers can be shared on a social networking website.

Alternatively, the selection can be directed at self-identifying the user in an engaging way. Rather than entering dry demographic facts, the selection graphics/text can give options, such as what “tribe” or “type” are you, such as “nerd,” “social butterfly,” “patriot,” “cheerleader,” “outdoorsman,” etc.

Referring to FIG. 13, for example, adaptive questioning and recommendation may be implemented in a self-profiling program. A mobile device 700 has a graphical user interface 702 that is depicted as rendering a profile screen 704 that enables a user to directly provide user profile information, such as keystone information, to the system. Such a profile screen 704 may be combined with other personal assistance such as being able to download contacts and personal information from other social or professional networking sites. Incorporating utilities such as calendars and event reminders can further engage the subscriber into using the device 700 for more activities. Thereby, more opportunities are created for determining characteristics of the user and for finding additional chances to present a recommendation.

Referring to FIG. 14, for example, adaptive questioning and recommendation may be implemented in another style of a selection-type program that provides an interactive game to help determine user interests or likes and dislikes. A mobile device 800 has a graphical user interface 802 that is depicting items in an arcade game 804 wherein the items may be moved to provide an additional challenge, and the user may “shoot” items they do not like to destroy them, or net and discard them. For instance a reward can be offered for the disposition of a certain number of items, which correlate to items of no interest to the user. For touch capable interfaces 802, various types of gestures can be detected that can make selection/discarding quicker and more intuitive for the user.

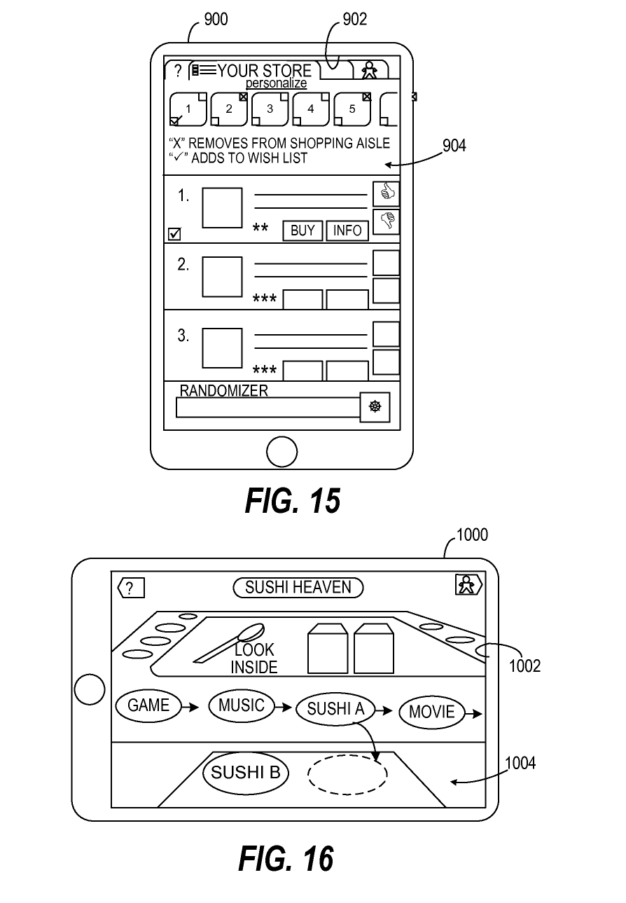

Referring to FIG. 15, for example, adaptive questioning and recommendation may be implemented in a shopping-type program. A mobile device 900 has a graphical user interface 902 that is depicting a “Your Store” page 904 as an animated carousel of applications, perhaps spun to an expected assortment by a randomizing wheel with those in view available for rating, selecting, discarding, pulling additional information, etc. For example, providing a guided tour of available applications can assist a new user who is unaware of a vast catalogue of applications that could be downloaded. A subscriber can bookmark certain offerings and obtain more information about certain applications.

Referring to FIG. 16, for example, adaptive questioning and recommendation may be implemented in a selection-type program. A mobile device 1000 has a graphical user interface 1002 that is depicting a “Your Store” page 1000 as a sushi restaurant game wherein certain items are various types of sushi from a moving carousel are placed on the tray to complete a collection for a prize. Non-sushi items, in this context, are recommended objects for rating, selecting for a wish list, or discarding in order to leave the sushi items.

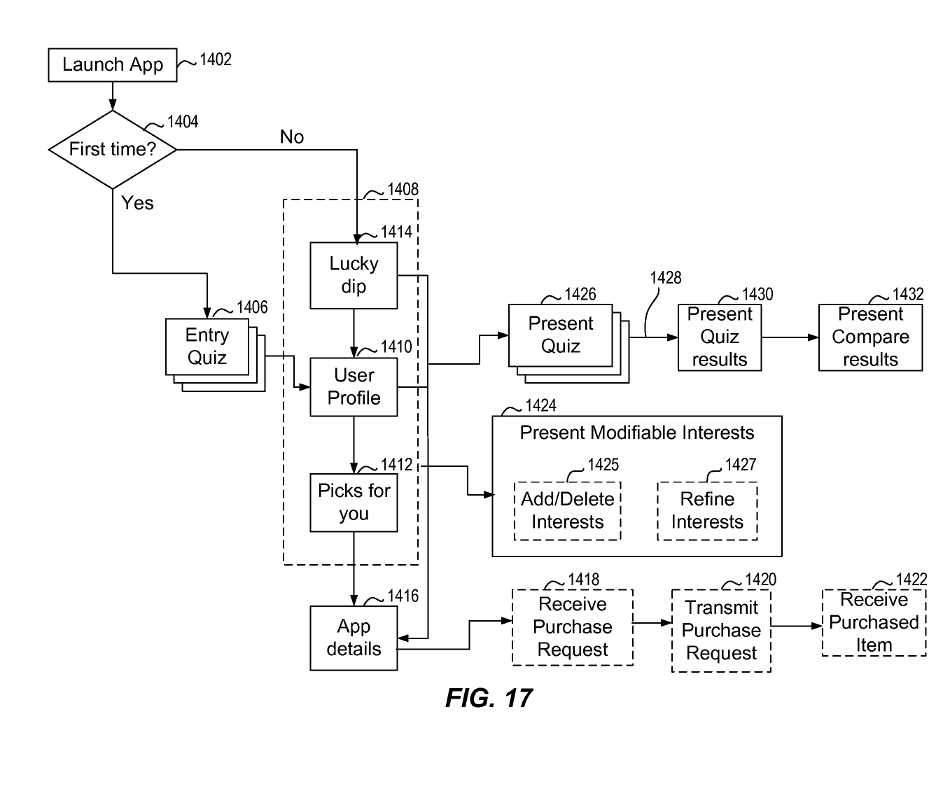

Referring to FIG. 17, in another example of an implementation of the aspects described herein, which should not be construed as limiting, a method 1400 of adaptive questioning and recommending may be initiated on a device by a user launching a recommendation application (Block 1402). The method 1400 may then further determine if the user who launched the application is a first time user (Block 1404).

If the user is a first time user, then the method 1400 may further include presenting one or more entry quizzes (Block 1406). For example, each of the one or more entry quizzes may include one or more keystone questions, interest identification questions, or optionally or in addition, one or more entertaining questions. As such, the one or more entry quizzes thereby enable the recommendation application to build at least a partial user profile that characterizes the user, e.g. with keystone data such as demographic or user interest data, as well as maintain the interest of the user in completing the quizzes by providing an entertainment factor. In an aspect, for example, the one or more entry quizzes may be designed to elicit a base set of keystone or interest data that may be used to generate recommendations to the user. For instance, the base set of data may include, but is not limited to, data such as a user age, a user gender, one or more user interests, a user-defined avatar or picture or graphic representation of them self, or any other configurable set of base data that may be desired by an operator of the present aspects in order to make one or more recommendations.

If the method 1400 determines that the user is not a first time user, or once at least a partial user profile has been created, e.g. via one or more entry quizzes (Block 1406), then the method 1400 further includes presenting a home page user interface to the user (Block 1408). From the home page user interface, the method 1400 may present one or more user-selectable options, such as options relating to the user profile, additional quizzes, or recommendations. In one aspect, for example, the presenting of the home page user interface to the user (Block 1408) may further include, or link to, presenting a user profile page user interface (Block 1410), and/or presenting a recommendations listing page user interface (Block 1412), and/or presenting a random recommendation page user interface (Block 1414). For example, in an aspect, the presenting of the user profile page user interface (Block 1410) may include, but is not limited to, presenting modifiable fields that include information that identifies the user, the interest items or characterizations of the user, and quizzes completed and/or available to take. Further, for example, the presenting of the recommendations listing page user interface (Block 1412) may include, but is not limited to, presenting a list of recommended items, such an application, a music file, a movie, or any other type of product or service. Moreover, the list of recommended items may be sortable, and/or divided into different categories, and/or modifiable by the recommendation application or by the user to present the recommended items in a desired order or category. Additionally, for example, the presenting of the random recommendation page user interface (Block 1414) may include, but is not limited to, a random selection of one of a plurality of recommended items, which may provide a degree of entertainment for the user as the user anticipates what type of item will be recommended.

Additionally, each or selected ones of the presented or linkable options on the home page user interface (Blocks 1410, 1412, and/or 1414) may lead to additional user interfaces for presenting recommendation details, for purchasing recommended items, or for gathering or allowing a user to define additional user profile information, such as user interests and keystone data.

For example, in one aspect, the method 1400 may further include presenting recommendation details (Block 1416). For instance, the recommendation may be a recommended product or service, such as content that may be downloaded to the device. Accordingly, for example, recommendation details may include, but are not limited to, information relating to the recommendation, such as a name of the product or service, a description, a supplier identification, a rating or recommendation level, a price, a sample or view of at least a portion of the product or service, or any other information that an operator of the present aspects may deem helpful in presenting to the user in order to aid in making a purchasing decision.

Additionally, in an aspect, the method 1400 may further include receiving a purchase request (Block 1418). For example, the method 1400 may provide the user with the option to purchase a product or service upon presenting the recommendations details. It should be noted, however, that the receiving of the purchase request may be made in response to the presentation of the recommendations listing, or from some other user interface. Moreover, the method 1400 may further include transmitting the purchase request (Block 1420) and receiving the purchased product or service (Block 1422). For instance, in an aspect, the device may wirelessly transmit the purchase request to a server that provides or arranges for delivery of the requested product or service, such as but not limited to content like an audio file, a music file, an application, etc.

In another example, in one aspect, the method 1400 may further include presenting modifiable user interests (Block 1424). For example, in an aspect, the presenting of modifiable user interests may include a list of identified interest items, along with a scaling factor that represents an application-determined or user defined level of interest. Optionally, the presenting of modifiable user interests may further include receiving a user input to add or delete an interest item (Block 1425), or to refine an interest item (Block 1427), such as to change a scaling factor.

In a further example, in one aspect, the method 1400 may also include presenting one or more quizzes (Block 1426), receiving user input quiz responses (Block 1428), and presenting quiz results (Block 1430). For example, in an aspect, the presenting of the one or more quizzes (Block 1426) may include presenting a quiz based on a received user selection that identifies a quiz of interest to the user, or presenting an application-determined quiz that is selected to gather missing user profile data, e.g. keystone data or user interests, or to further refine existing user profile data, or to test the limits of user interests, or to provide entertainment to the user without necessarily deriving user profile data, or some combination thereof. Further, for example, the receiving of the user input quiz responses (Block 1428) may include receiving at one or more user input mechanisms, such as a mechanical or virtual key, a microphone, a touch sensitive display, or any other type of user input mechanism. Also, for example, the presenting of the quiz results (Block 1430) may include a summary of the quiz responses or answers, or a conclusion or interest or keystone data determined by the recommendation application based on the quiz responses or answers, or a set of recommendations for content, based particularly on the most recent information learned about the user through their answers to questions, or some combination thereof. In an aspect, for example, the recommendations 125 provided by the described aspects may be based primarily on the new things the described aspects have just learned about the user, e.g. having just learned that the user likes attending live baseball games, the described aspects provide one or more recommendations 125, e.g. for content or offers, to the user that are specific to this new insight.

In an optional additional aspect, the method 1400 may further include presenting a comparison of the user input quiz responses, e.g., the quiz results (from Block 1430), with the corresponding responses of some other population of users (Block 1432). For example, the presenting of the user input quiz responses with the corresponding responses of some other population of users (Block 1432) may be responsive to a user input of a comparison request in response to the presenting of the quiz results. Moreover, the recommendation application may communicate with a network based server having historical information of quiz responses for one or more populations of users, or the recommendation application or the user device may store all or some portion of the historical information, e.g. a portion of the historical information that corresponds to the one or more quizzes taken by, or available to be taken by, the user.

Optionally, although not illustrated in FIG. 17, each action of method 1400 may link to a prior action, or to any other action. For example, upon presenting quiz results (Block 1430), the method 1400 may return to presenting quizzes (Block 1426) or to presenting the home page user interface (Block 1408) or to presenting the user profile user interface (Block 1410) or to presenting recommendations (Block 1412 or 1414). In another example, upon presenting a recommended item detail (Block 1416), the method 1400 may further include receiving a user input to return to the presenting of the modifiable user interests (Block 1424), and further including receiving user inputs to change, add, or delete an interest item or a scaling factor associated with an interest item.

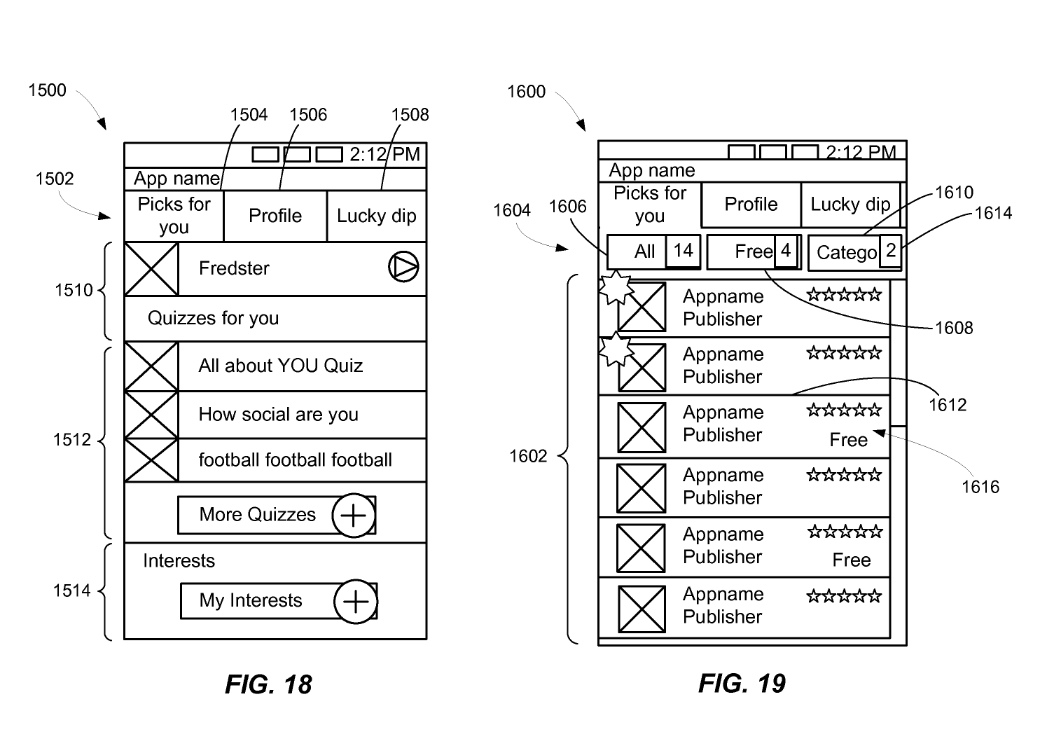

Referring to FIGS. 18-27, various examples of user interfaces corresponding to the method 1400 of FIG. 17 are illustrated, however, it should be understood that these examples are not to be construed as limiting, and that the user interfaces associated with the method 1400 of FIG. 17 may be configured in any manner suitable to an operator of the recommendation application described herein.

Referring to FIG. 18, for example, one aspect of a home page user interface 1500 includes a plurality of selectable additional user interfaces 1502, such as a recommendation list page (also referred to as “Picks for you”) 1504, a user profile page 1506, and a random recommendation page (also referred to as “Lucky dip”) 1508. In FIG. 18, the user profile page 1506 is selected, which in one aspect generates summary fields that can be selected or expanded to provide more details or to access additional pages. For example, such fields may include one or more of: a user data field 1510, which may include a name or nickname for the user and which may be expanded to list other user-specific information, such as user demographics; one or more quiz-related fields 1512, for example, listing quizzes completed or enabling more quizzes to be taken; and an interests field 1514, which may list or provide a link to a listing of user-defined or application-determined user interests.

Referring to FIG. 19, for example, one aspect of a recommendation listing user interface 1600, also referred to as a “picks for you” user interface, includes a list of recommended items 1602. The list of recommended items 1602 may be categorized, such a by user selectable categorizations keys 1604, that provide one or more different sets or subsets of recommended items. For example, user selectable categorizations keys 1604 may include but are not limited to an all recommendations listing 1606 that lists all recommended items, a price-based (e.g. “free”) recommendations listing 1608 that lists recommendation items having a given price or range of prices, or one or more user or application-defined interest- or category-specific recommendation listings 1610 that list recommendations only in a certain category, which may be determined based on metadata associated with each recommended item. Also, one or more of the user selectable categorization keys 1604 may include a counter, such as counter 1614, that identifies a number of recommended item in the respective category. Additionally, each recommended item, such as recommended item 1612, in each listing may include item information 1616 such as, but not limited to, an item identifier or name, an item description, an item rating or recommendation level, an item price, etc.

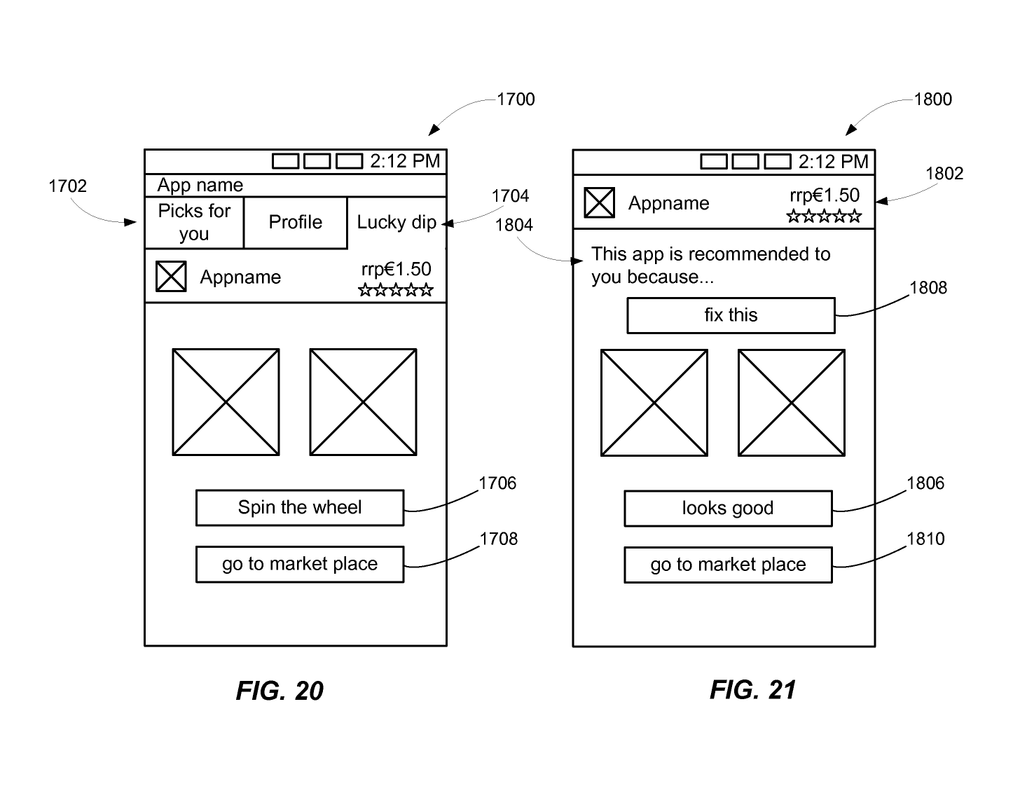

Referring to FIG. 20, for example, one aspect of a random recommendation listing user interface 1700, also referred to as a “Lucky dip” user interface, includes at least one recommended item 1702, which may randomly be selected by the recommendation application from a plurality of recommended items. Similar to the recommended items 1602 in the recommendation listing user interface 1600 (FIG. 19), recommended item 1702 may include item information 1704 such as, but not limited to, an item identifier or name, an item description, an item rating or recommendation level, an item price, etc. Further, in an optional aspect, random recommendation listing user interface 1700 may further include a get new item key (also referred to as a “spin the wheel” key) 1706 to request another randomly selected recommendation item, thereby providing an additional gaming experience. Moreover, in an optional aspect, random recommendation listing user interface 1700 may further include a purchase key (also referred to as a “go to market place” key) 1708, which initiates a purchasing process to request, pay for, and subsequently receive the randomly recommended item 1702.

Referring to FIG. 21, for example, one aspect of a recommended item detail user interface 1800 includes recommended item information 1802. Similar to the recommended item information 1616 (FIG. 19) and 1704 (FIG. 20), recommended item information 1802 may include, but is not limited to, information such as one or more of an item identifier or name, an item description, an item rating or recommendation level, an item price, etc. Additionally, in an optional aspect, recommended item detail user interface 1800 provides feedback mechanisms to explain why an item was recommended, such as rationale description 1804, and/or to enable the user to confirm whether or not the recommended item 1800 is of interest to the user, such as a confirm key (also referred to as a “looks good” key) 1806, and/or to enable the user to revise the user profile, user interests or scaling factor, or keystone data, such as a revise key (also referred to as a “fix this” key) 1808. Moreover, in an optional aspect, recommended item detail user interface 1800 may further include a purchase key (also referred to as a “go to market place” key) 1810, similar to purchase key 1708 (FIG. 20), which initiates a purchasing process to request, pay for, and subsequently receive the recommended item 1800.

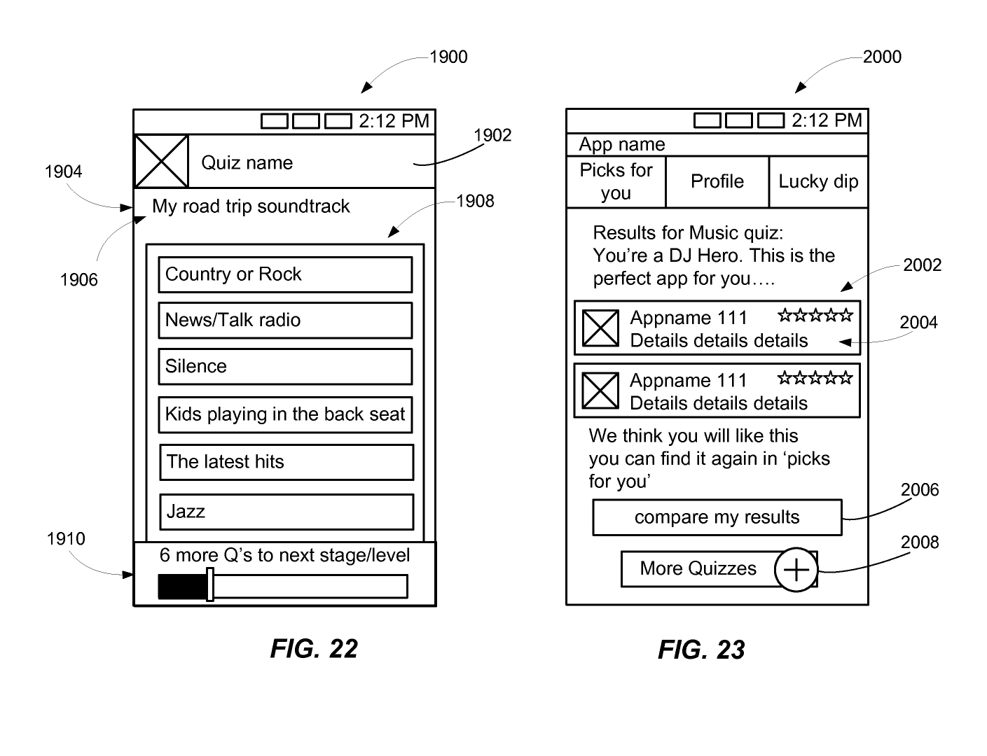

Referring to FIG. 22, for example, one aspect of a quiz user interface 1900 includes a quiz identifier 1902, such as a name or description, and one or more quiz questions 1904. Quiz user interface 1900 is representative of one of a plurality of quizzes that may be provided to a device user by the recommendation application described herein. The one or more quiz questions 1904 may be in any one of a variety of formats, such as, but not limited to, including a question 1906 and one or more selectable answers 1908. Moreover, in an aspect where the respective quiz user interface 1900 provides a question 1904 that is part of a set or sequence of questions associated with a given quiz, then quiz user interface 1900 may further include a progress indicator 1910 that provides feedback to the user as to how far through the sequence they have gone, and/or as to how many more questions remain in the sequence (e.g. “6 more Q′s to next stage/level”). The progress indicator 1910 may include one or more of text, a graphic (e.g. a bar that has an indicator and/or shading to show a percentage or level of completion), an audio file, or any output that provides the user with feedback relating to advancement though the sequence of questions on a quiz.

Referring to FIG. 23, for example, one aspect of a quiz results user interface 2000 may include one or more recommended items 2002 and at least a portion of item information 2004 that describe one or more of the item, a cost for the item, a rating for the item, etc. It should be noted, however, that each quiz results user interface 2000 may not include one or more recommended items 2002, but may instead, or in addition, summarize the answers to the quiz, or instead or in addition may include one or more interests or keystone data derived or inferred from the answers to the quiz. In an optional aspect, quiz results user interface 2000 may further include a compare key 2006 that links to a quiz results comparison user interface, which is described in more detail below. In another optional aspect, quiz results user interface 2000 may additionally include an additional (or “more”) quizzes key 2008 that links to a user interface where the user may select additional quizzes to complete.

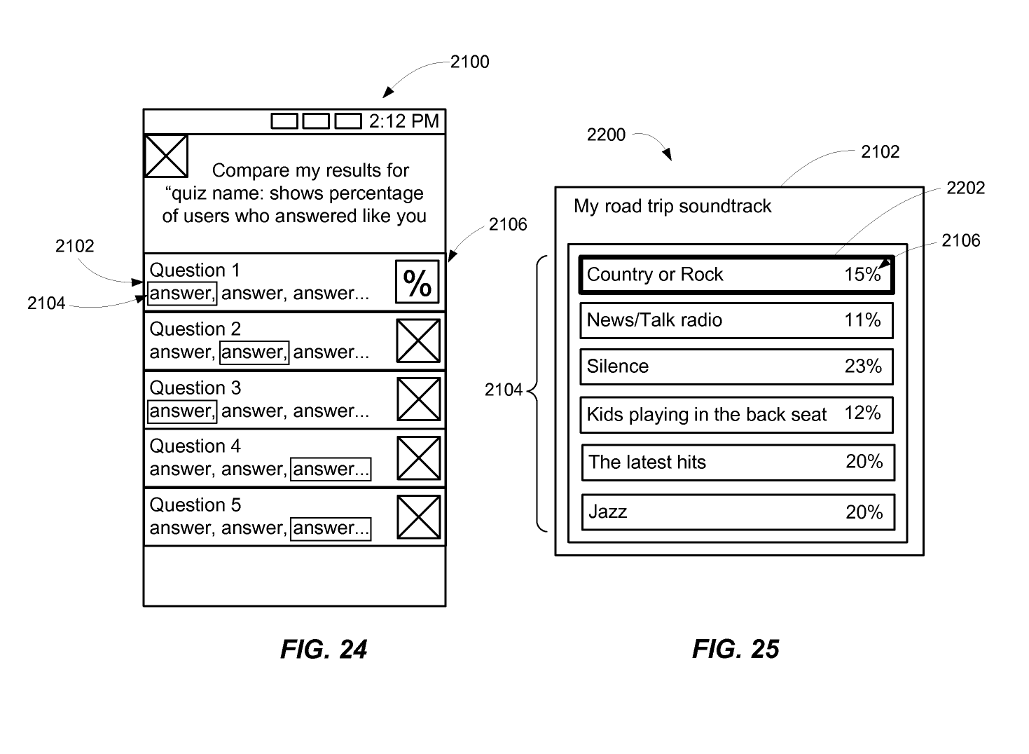

Referring to FIG. 24, for example, one aspect of a quiz results comparison user interface 2100 may include a summary having a question identifier 2102 that describes each question, each answer 2104 for each question, as well as one or more indicators 2106 of a measure of a population of users relating to each answer. For example, the one or more indicators 2106 may be measures of one or more of: the population of users that selected the same answer as the user, or that selected each answer, or that selected the same combination of answers as the user. Further, for example, the one or more indicators 2106 may include but not limited to a numerical percentage or a graphical representation. It is noted that FIG. 24 represents the specific example of a user interface that identifies the user combination of answers, as indicated by the bold “answer” under each “Question,” and the percentage of the population of users with the same answers. Thus, in this example, quiz results comparison user interface 2100 allows the user to compare how many of the population of users had the same combination of answers as the user.

Referring to FIG. 25, for example, one aspect of the quiz results comparison user interface 2100 may further include a question results comparison user interface 2200, which may be generated when a user selects a specific one of the question identifiers 2102 of FIG. 24. For example, question results comparison user interface 2200 includes the selected question identifier 2102, each answer 2204, a respective indicator 2106 of the population of users who selected the respective answer, and also an indicator 2202, such as highlighting, of the user selected answer. Thus, in this example, question results comparison user interface 2200 allows the user to compare their answer to the answers of the population of users.

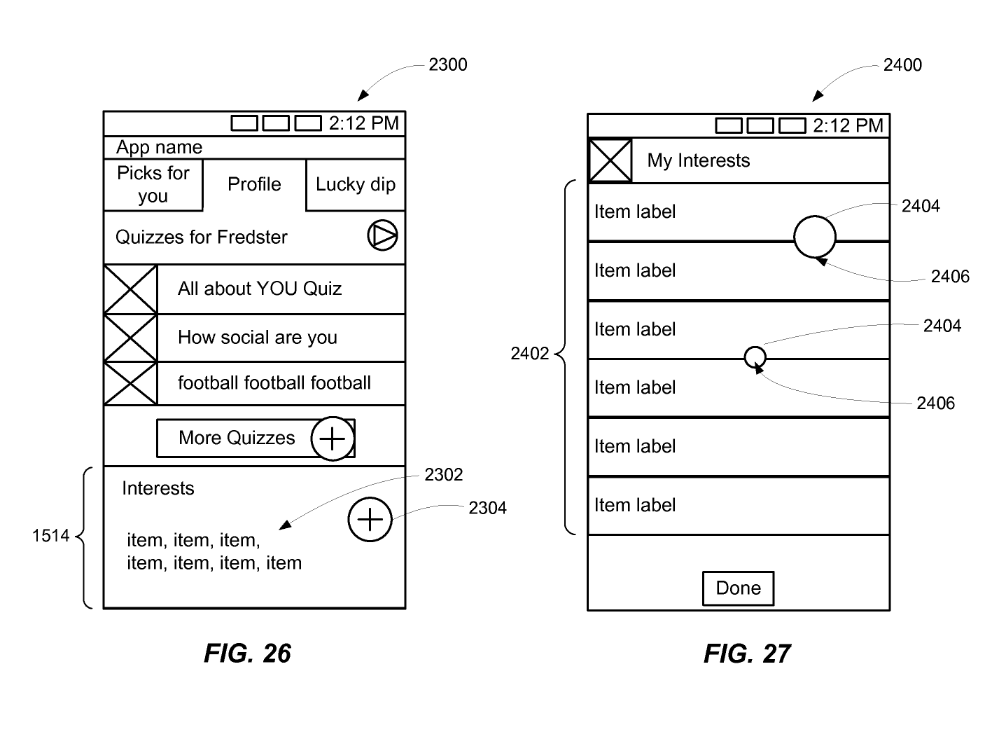

Referring to FIG. 26, for example, after completing one or more quizzes, such as an entry quiz or a subsequent quiz, may include an interests portion 2302, one aspect of a user profile user interface 2300, similar to user profile page 1506 (FIG. 18), includes interests field 1514 having one or more identified interest items 2302. The one or more identified interest items 2302 may include, but are not limited to, items directly identified by the user to be of interest to the user, or items derived or inferred from one or more answers to one or more quizzes. In an aspect, for example, at least a portion of the one or more identified interest items 2302 may include words that represent or correspond one or more categories, such as the categories associated with user selectable categorizations keys 1604 (FIG. 19). In some aspects, the one or more identified interest items 2302 presented in interests field 1514 may not include all interests corresponding to a user, but only a subset thereof, e.g. such as identified interests that achieve a threshold level of interest to the user, or such as a set number of interests, optionally ordered based on an interest level of the user. In an optional aspect, interests field 1514 may further include an interest list link 2304, which when selected by the user generates an identified interests listing user interface.

Referring to FIG. 27, for example, one aspect of an identified interests listing user interface 2400 may include identified interests 2402 of the user. Optionally, identified interests listing user interface 2400 may include a scaling factor 2404 for one or more of identified interest items 2402, where each scaling factor 2404 represents an application-determined or user defined level of interest. For example, in FIG. 27, scaling factors 2404 are positioned along a horizontal line, where a position to the right indicates a higher level of interest relative to a position on the left, e.g. a horizontal scale from 0 to 100 moving from left to right. In some aspects, each scaling factor 2404 may be user adjustable, thereby enabling a user to modify or otherwise identify their level of interest in a respective identified interest item 2402. Additionally, in some aspects, each scaling factor 2404 may include one or more additional confidence indicators 2406, such as but not limited to a relative size or measure, a shading or coloring, etc., to indicate one or more of an application-determined versus user identified level of interest, or to indicate a relative confidence in the value of the respective scaling factor 2404. For example, in an aspect, the user may not be able to modify the computed, e.g. application-determined, confidence level (e.g. “we are 75% sure that you like Baseball”), however, the user may be able to modify a scaling factor 2404 representing a user-defined level of interest to inform the system directly that they like Baseball. In such an instance, the described aspects may indicate (e.g., via shading) the level of confidence as 75%, but if subsequently the user informs that system that they definitively like baseball, then the described aspects change confidence indicator 2406, e.g. shading, to a more definitive shade or color (as may be defined by the described aspects).

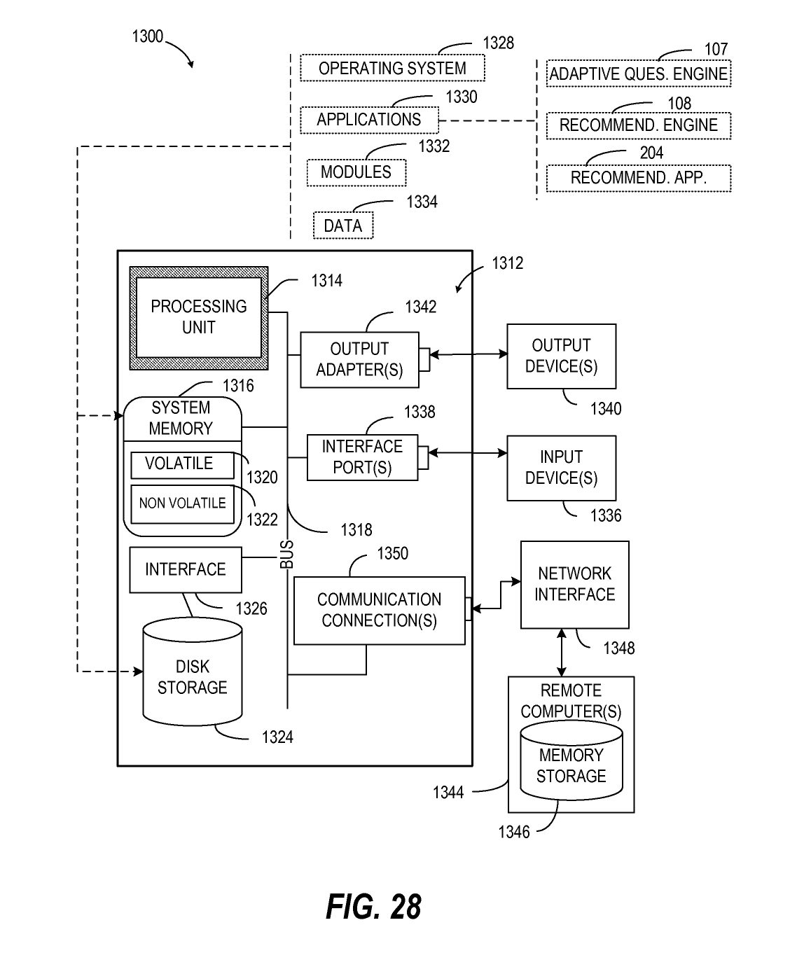

With reference to FIG. 28, an exemplary environment 1300 for implementing various aspects of the claimed subject matter includes a computer 1312 programmed in hardware, or software, or a combination thereof, to perform the adaptive questioning and recommending functionality described herein. For example, computer 1312 may include a network device performing the network-side functionality described herein, or computer 1312 may include a client device, such as a wireless device, that performs the client-side functionality described herein. In any case, the computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable programmable ROM (EEPROM), or flash memory. Volatile memory 1320 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1312 also includes removable/non-removable, volatile/non-volatile computer storage media, such as but not limited to disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used such as interface 1326.

It is to be appreciated that FIG. 28 includes software that acts as an intermediary between users and the basic computer resources described in the suitable operating environment 1300. Such software includes an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. In an aspect, for example, applications 1330 may include one or more of adaptive questioning engine 107 (FIG. 1), recommendation engine 108 (FIG. 1), or client questioning and recommendation application 204 (FIG. 3). It is to be appreciated that the claimed subject matter can be implemented with various operating systems or combinations of operating systems, with various applications, with various modules, or any combination thereof.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312 and to output information from computer 1312 to an output device 1340. Output adapter 1342 is provided to illustrate that there are some output devices 1340 like monitors, speakers, and printers, among other output devices 1340, which require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

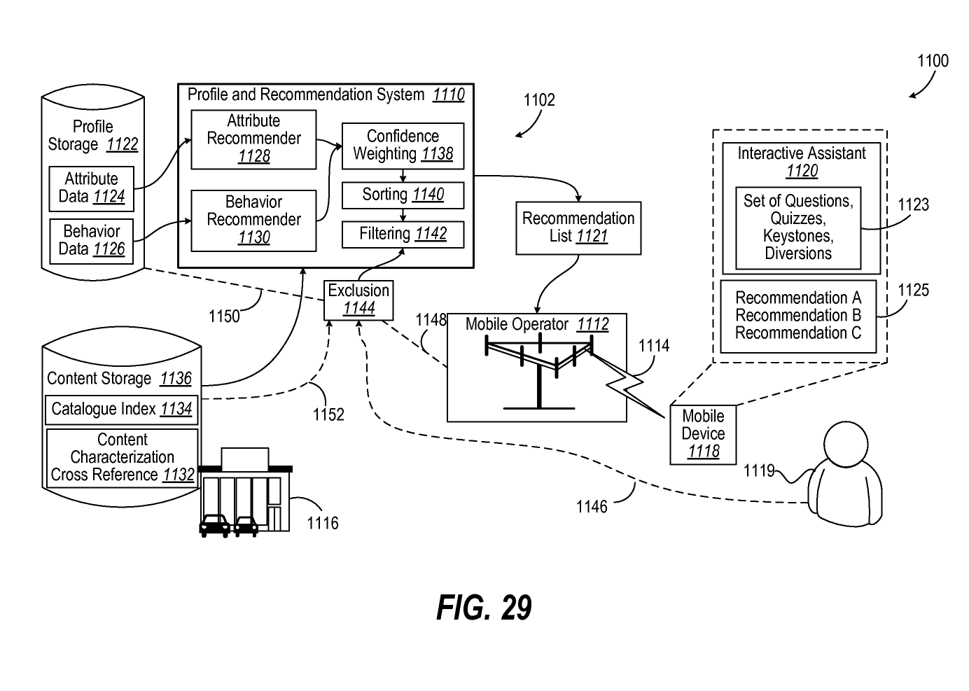

Referring to FIG. 29, in an exemplary aspect a distributed recommendation system 1100 is performed across a wireless communication system 1102. In particular, the present aspects provide a profile and recommendation system 1110 that enables mobile operators 1112 of a wireless communication network 1114 and their business partners, depicted as content providers 1116, to proactively promote the uptake of content and services to their subscriber base, depicted as a mobile device 1118 of a subscriber 1119. Initially, an interactive assistant 1120 is provisioned with a set of questions 1123, including quizzes, keystone, questions, and entertaining or diversion questions, and optionally recommendations 1125, and can autonomously generate queries, or elicit responses to the recommendations as queries, in order to begin or to enhance characterizing the subscriber 1119. In one example, this is achieved by the generation of a list of recommendations 1121 tailored for the particular subscriber 1119 for delivery to their mobile device 1118. The recommendations can be displayed either on the portal associated with the mobile operator, or be delivered to the mobile device by mobile messaging, for example.

According to one aspect, a profile storage 1122 comprises attribute data 1124 or behavior data 1126. A corresponding plurality of recommenders, depicted as an attribute recommender 1128 and a behavior recommender 1130 associate the respective data 1124, 1126 with content characterization cross reference 1132 of a catalogue index 1134 of content storage 1136. Preliminary recommendations from the recommenders 1128, 1130 have a confidence level assigned by a confidence weighting component 1138. For example, a weak or strong association may be determined As another example, an attribute or behavior may be weakly determined through inferential analysis of limited occurrences or be a strongly determined through explicit inputs or repeated behaviors. The weighted preliminary recommendations can then be sorted by a sorting component 1140.

Prior or subsequent to sorting, a filtering component 1142 implements an exclusion 1144 to avoid an inappropriate recommendation. Exclusions 1144 can be expressly specified by the subscriber 1119, as depicted at 1146, such as restricting certain categories of recommendations that would be objectionable, or providing other recommendation settings that filter specific types or categories of recommendations. Exclusions 1144 can be specified by the mobile operator 1112, as depicted at 1148, such as specifying computing platform targets suitable for the content (e.g., audio files suitable for a mobile device with an MP3 media player). Exclusions 1144 can also be drawn from profile data 1124 and/or 1126, depicted at 1150, such as tracking of purchases of content that would otherwise be recommended again or recommendations repeatedly ignored by the subscriber 1119. Exclusions 1144 can also be drawn from content providers 1116, which can be the mobile operator 1112, by providing device or software configuration compatibility information, depicted at 1152. Thereby, mobile devices 1118 that cannot successfully use recommended content are excluded.

The recommendations are generated by an analysis of the subscriber information available to the mobile operator 1112 in conjunction with the content and services offered, so as to determine those content and services, which are likely to be of the most interest to the subscriber. In particular, the profile and recommendation system 1110 also enables the recommendations to be delivered to the subscriber 1119 at those times which have been determined to be when the subscriber 1119 is most amenable to purchasing based on attribute or behavior assessment as an individual or group member. The profile and recommendation system is also adapted to generate promotions, when it is desired to actively promote a particular content or service to its subscriber base.

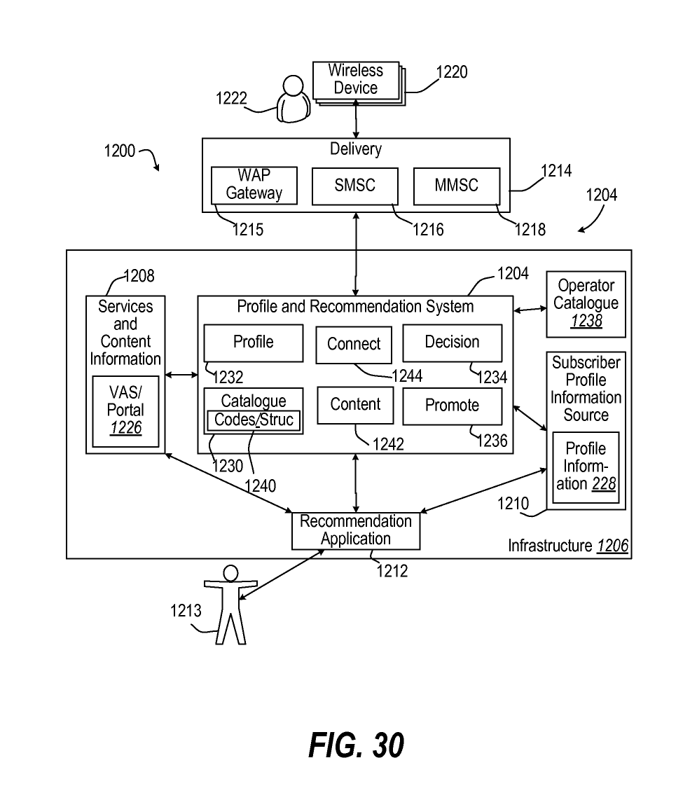

In an additional aspect, in FIG. 30 a recommendation network 1200 depicts interactions between certain components associated with a mobile operator 1202 and a profile and recommendation system 1204 of the present disclosure. These systems may be directly integrated in a mobile operator's communications infrastructure 1206, or alternatively may be part of a system of a business partner associated with the mobile operator. The infrastructure 1206 can include a services and content information component 1208, a subscriber profile information source 1210, and a recommendation application 1212 used by an administrator 1213. The profile and recommendation system 1204 interfaces with content delivery system 1214, which can comprise a WAP gateway 1215, Short Message Service Centre (SMSC) 1216, and Multimedia Messaging Service Centre (MMSC) 1218 and which in turn communicates with wireless devices 1220. The content delivery system 1214 provides content delivery capability via connection to network systems such as WAP gateways 1215, SMSCs 1216, MMSCs 1218. This enables the profile and recommendation system 1204 to deliver and receive any type of mobile content or service to users or subscribers 1222 of wireless devices 1220 in communication with the content delivery system 1214. This capability can be implemented where the profile and recommendation system 1204 is used to deliver promotional information (e.g., via SMS, MMS, WAP Push, etc.) and where the profile and recommendation system 1204 is responsible for content delivery fulfillment (e.g., polyphonic ringtone, wallpaper, shopping, games, etc.).

The services and content information component 1208 can comprise external platforms such as Value Added Services (VAS) or portal 1226 with which the profile and recommendation system 1204 can communicate. In one example, integration with VAS platforms 1226 can facilitate the creation of a complete catalogue of content available to the mobile subscriber 1222 of one or more wireless devices 1220. This allows the profile and recommendation system 1204 to more intelligently retail the available content or services on offer by a mobile operator or its partners. Integration with portal 1226 enables the delivery of targeted promotions to those users or subscribers 1222 that use the portal 1226, and enables the capturing of information component 1228 about their behavior (e.g., keystroke technique, facial expression, biometric reading, pattern of interaction, etc.) for later referencing from the subscriber profile information source 1210. In one instance, the subscriber profile information 1228 includes one or more of call data; gender; date of birth; prior purchases; expressions of interest or disinterest; spending pattern; mobile device type, current geographical location, call frequency or other metadata.

FIG. 30 further provides details of illustrative main components of the profile and recommendation system 1204, according to one aspect. These include a catalogue module 1230, a profile module 1232 a decision module 1234 and a promote module 1236. The catalogue module 1230 enables the profile and recommendation system 1204 to be utilized as a central catalogue for a large amount of content or services. In this manner, a more detailed picture of the available content/services can be provided to other systems (e.g., a portal, etc.), thus enabling a better management of the content retailing process.

According to one example, operator catalogue 1238 maintained by a mobile operator in a centralized location may include a complete catalogue of voice, data, and other services provided by the operator. In one instance, the catalogue module 1230 can maintain the product ID codes and structures 1240 that are defined in the mobile operator's central catalogue 1238.

The content module 1242 provides content management and delivery capability for a range of content or services. Connect module 1244 enables the delivery of SMS, MMS, WAP, and downloadable content. According to one example, all industry standard network connectivity and delivery protocols are supported. The content module 1242 can operate to integrate with a subscriber profile information source 1210, such as billing, for charging for the content or services. In addition, content module 1242 can integrate with pre- and post-paid systems via a variety of protocols. Content module 1242 can also integrate with the services and content information block 1208 to show available content or services on the web or WAP portals (e.g., title, artist, previews, etc.) and to trigger delivery of content or services.

In one example, content module 1242 offers the ability to locally store, manage, and deliver any content type. Content and information can be securely stored and managed via a web interface, for example, and delivered via carrier-grade download, alert, and on-demand content servers.

The profile and recommendation system can further support a variety of mechanisms for the automatic acceptance and collection of content from external sources. The platform can be configured to accept content feeds in the form of HTTP/XML or File Transfer Protocol (FTP)/XML from external sources, and provide a framework for implementing content provider specific mechanisms for content integration. According to one aspect, the profile and recommendation system can also proactively retrieve content from external sources such as RSS. In one example, the profile and recommendation system content submission API can be used by content providers to manage their content using a defined XML format over HTTP.

Content module 1242 can further be configured to provide active or inactive update, depending on the type of content validation that may be required. The administrator 1213 can provision the type of authorization required for each type of content. In one example, trusted content can be automatically validated, whereas other types of content may require approval from the administrator 1213 or the mobile operator's content manager.

Furthermore, content module 1242 can support the creation and management of subscription based alerts as well as delivering SMS, MMS, or other content types. Subscribers can create a schedule of personalized alerts specific to their interests with the ability to define parameters such as bearer (e.g., SMS v MMS, etc.), time of day delivery, language, time zone, etc. The alert module of the content module 1242 has the ability to scale to the requirements of the mobile operators, providing timely delivery of content or services.

According to one example, the content download module provides download server for all downloadable types of content including, without limitations, Java, ringtones, wallpapers, etc. In one example, the content download module provides the following features: (A) Delivery of Java applications (e.g., games, etc.), Java Archive (JAR) or Java Application Development (JAD) format (2 stage download); (B) Each download can be assigned a unique URL and can have its own token ID; (C) JAD file is rewritten to specify dynamic location of JAR download; (D) Download retries can be allowed for a configurable period of time or number of attempts; (E) Digital rights management (DRM) can be applied to downloaded content; (F) Download can be initiated via WAP push or directly from the WAP portal; and (G) The CSR interface for user activity lookup is based on Mobile Subscriber Integrated Services Digital Network Number (MSISDN), with the capability to resend download if required.

The module can be configured to use substantially all possible standards and techniques to ensure successful download and accurate billing of downloaded content. This can include a download notification API that allows the download server to notify an external system as the different stages of the download happen. These notifications can be used to stop the download at any point, or generate billing events.

According to one example, the connect module 1244 can be configured to have Digital Rights Management (DRM) capability, which provides the ability to apply Open Mobile Alliance (OMA) DRM v1 Forward Lock, Combined Delivery and Separate Delivery to selective content as defined by the platform administrator or content providers.

In one aspect, connect module 1244 includes a transcoding engine that can be configured to support transcoding between a wide variety of content formats and codecs. In addition, the transcoding engine can be configured to provide its own device profile database that is tested and tuned specifically for the purpose of delivering multimedia content.

According to one aspect, the connect module 1244 can handle three content delivery scenarios, as follows:

Scenario 1. Information on Demand: In this scenario, the services or content requests are handled by mapping the services or content requests to the relevant content source, retrieving the current content or service from that source, and returning it to the subscriber;

Scenario 2. Scheduled Delivery: Scheduled delivery can be based either on a fixed delivery schedule specified by the system administrator 1213 or on a subscriber defined schedule. In this situation content or services are retrieved and delivered to subscribers at the times specified in their schedules; and

Scenario 3. Unscheduled Delivery: Delivery of unscheduled content or services can be triggered either manually or automatically via an external event. In this situation, content or service is pushed to subscribers from the content or service source.

Content module 1244 can be integrated with an existing portal via the provided Portal API, or in situations where an existing storefront is being replaced, content module 1242 can provide a storefront that can be customized to a mobile operator's requirements. Content module 1244 further provides an “out-of-the-box” storefront, which enables mobile operators to merchandise content or services across multiple storefronts and multiple delivery channels. This default storefront can be customized to meet the functionality and branding requirements of a specific mobile operator.

In one example, because the storefront has been pre-integrated with the rest of the profile and recommendation system, the storefront can make best use of the overall system features. According to one aspect, the storefront can allow the mobile operator to: (A) Offer a comprehensive range of services to subscribers; (B) Promote new services; (C) Create offers around content bundles; (D) Provide a “user-friendly” interface for subscribers to purchase and subscribe to content services; (E) Display market segment-specific versions of the storefront; and F) Create top-ten lists to promote new/popular services.

Additionally, the storefront can allow the subscriber to: (A) View the complete range of content services on offer (either all services or services available in their market segment); (B) Purchase content services (e.g., games, ringtones, etc.); (C) Subscribe to content services (e.g., alerts, etc.); (D) Manage their subscriptions to content services; and (E) Specify their own schedule for delivery of content.

In the situation where content or service is to be sold over different channels, the profile and recommendation system can be configured with multiple storefronts. For example, a mobile operator may market its content or services through multiple brands or resellers. In one example, a customized storefront can be supported for each channel.

Content module 1244 can further be configured to provide a secure, reliable, and audited mechanism of storing and managing content. In one instance, security is provided via SSL and username/password authentication. According to one example, access to content can be segregated, thus restricting content providers to accessing their own content. Content review and authorization can be performed either by platform administrator 1213 or by external content owners.

In one aspect, intelligent content selection can be used to ensure that the type of content offered by providers can be delivered in an optimal format that matches the capabilities of a user or subscriber's device. By mapping device capabilities to devices and content or service items, determination can be made by the profile and recommendation system as to which service or piece of content to deliver. Where a device has a number of device capabilities, the profile and recommendation system can use a system of weighting to determine the most appropriate content to deliver.

With continued reference to FIG. 30, in one example, data for catalogue and profile modules 1230 and 1232, correspondingly, can be imported from systems (e.g., billing, CRM, Valued Added Services (VAS) platforms (e.g., alerts platform, etc.), etc.) via connect module 1244. In one aspect, connect module 1244 provides a way of simplifying and automating the import and export of information for the profile module 1232 and the catalogue module 1230 into and out of the profile and recommendation system 1204.

In one exemplary aspect, recommendations can be provided as disclosed in U.S. patent application Ser. No. 12/237,864, “RECOMMENDATION GENERATION SYSTEMS, APPARATUS AND METHODS” to O'Donoghue et al., filed Sep. 25, 2008, published as Publ. No. 20090163183 A1 on Jun. 25, 2009, which claimed priority to Provisional Application No. 60/997,570 of the same title filed Oct. 4, 2007, both assigned to the assignee hereof and hereby expressly incorporated by reference herein.

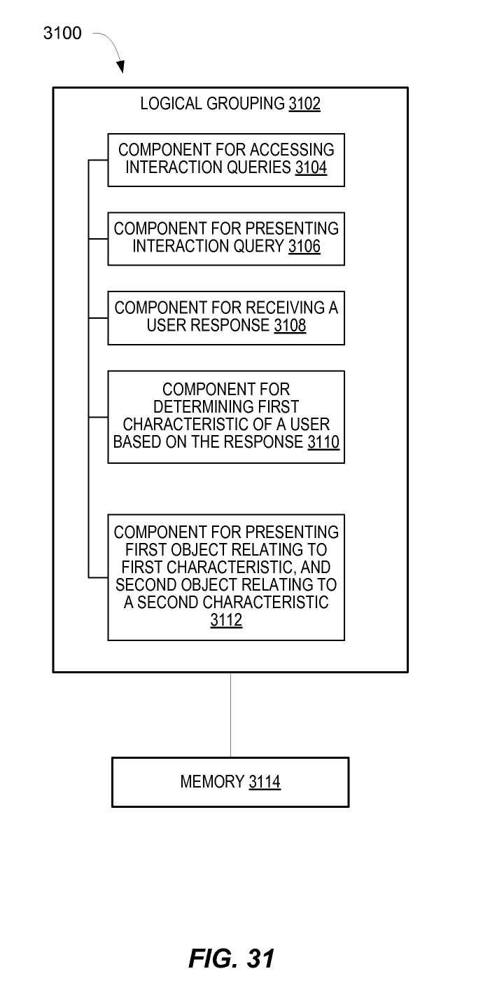

Referring to FIG. 31, in one aspect, a system 3100 for adaptive questioning and recommending may include at least one network device, at least one mobile client device, or may be distributed there between. System 3100 includes functional blocks that can represent functions implemented by a processor, software, or combination thereof (e.g., firmware). In an aspect, for example, system 3100 includes a logical grouping 3102 of electrical components that act in conjunction. Logical grouping 3102 may include a component 3104 for accessing interaction queries. Moreover, logical grouping 3102 may include a component 3106 for presenting at least one interaction query. Further, logical grouping 3102 can include a component 3108 for receiving a user response. Also, logical grouping 3102 may further include a component 3110 for determining at least a first characteristic of the user based on the user response. Additionally, logical grouping 3102 may also include a component 3112 for presenting a first object relating to the first characteristic and for presenting a second object relating to a second characteristic. Additionally, system 3100 can include a memory 3114 that retains instructions for executing functions associated with electrical components 3104, 3106, 3108, 3110, and 3112. While shown as being external to memory 3114, it is to be understood that electrical components 3104, 3106, 3108, 3110, and 3112 can exist within memory 3114.

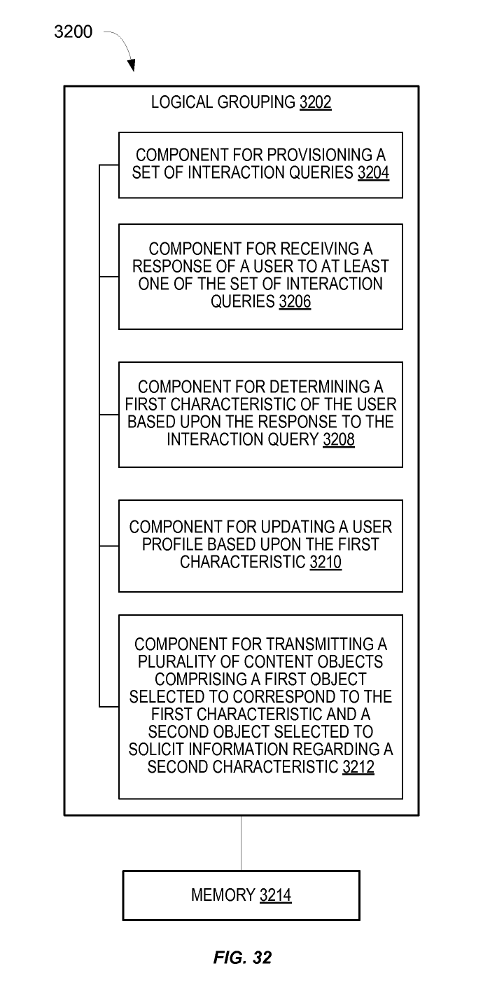

Referring to FIG. 32, in one aspect, a system 3200 for adaptive questioning and recommending may include at least one network device, at least one mobile client device, or may be distributed there between. System 3200 includes functional blocks that can represent functions implemented by a processor, software, or combination thereof (e.g., firmware). In an aspect, for example, system 3200 includes a logical grouping 3202 of electrical components that act in conjunction. Logical grouping 3202 may include a component 3204 for provisioning a mobile device with a set of interaction queries, each query from the set of interaction queries associated with a decision association and a presentation instruction. Moreover, logical grouping 3202 may include a component 3206 for receiving a report from the mobile device that indicates a response of a user to the at least one of the set of interaction queries that was presented in accordance with the presentation instruction. Further, logical grouping 3202 can include a component 3208 for determining a first characteristic of the user based upon the response to the interaction query. Also, logical grouping 3202 may further include a component 3210 for updating a user profile based upon the first characteristic. Additionally, logical grouping 3202 may also include a component 3212 for transmitting a plurality of content objects to the mobile device for user interaction comprising a first object that is selected to correspond to the first characteristic and comprising a second object that is selected to solicit information regarding a second characteristic, wherein the second characteristic comprises a desired characteristic to be known about the user. Additionally, system 3200 can include a memory 3214 that retains instructions for executing functions associated with electrical components 3204, 3206, 3208, 3210, and 3212. While shown as being external to memory 3214, it is to be understood that electrical components 3204, 3206, 3208, 3210, and 3212 can exist within memory 3214.

Various aspects of the disclosure have been described above. It should be apparent that the teaching herein can be embodied in a wide variety of forms and that any specific structure or function disclosed herein is merely representative. Based on the teachings herein one skilled in the art should appreciate that an aspect disclosed herein can be implemented independently of other aspects and that two or more of these aspects can be combined in various ways. For example, an apparatus can be implemented or a method practiced using any number of the aspects set forth herein. In addition, an apparatus can be implemented or a method practiced using other structure or functionality in addition to or other than one or more of the aspects set forth herein. As an example, many of the methods, devices, systems, and apparatuses described herein are described in the context of providing dynamic queries and recommendations in a mobile communication environment. One skilled in the art should appreciate that similar techniques could apply to other communication and non-communication environments as well.

As used in this disclosure, the term “content” and “objects” are used to describe any type of application, multimedia file, image file, executable, program, web page, script, document, presentation, message, data, meta-data, or any other type of media or information that may be rendered, processed, or executed on a device.

As used in this disclosure, the terms “component,” “system,” “module,” and the like are intended to refer to a computer-related entity, either hardware, software, software in execution, firmware, middle ware, microcode, or any combination thereof. For example, a component can be, but is not limited to being, a process running on a processor, a processor, an object, an executable, a thread of execution, a program, or a computer. One or more components can reside within a process or thread of execution and a component can be localized on one computer or distributed between two or more computers. Further, these components can execute from various computer readable media having various data structures stored thereon. The components can communicate by way of local or remote processes such as in accordance with a signal having one or more data packets (e.g., data from one component interacting with another component in a local system, distributed system, or across a network such as the Internet with other systems by way of the signal). Additionally, components of systems described herein can be rearranged or complemented by additional components in order to facilitate achieving the various aspects, goals, advantages, etc., described with regard thereto, and are not limited to the precise configurations set forth in a given figure, as will be appreciated by one skilled in the art.

Additionally, the various illustrative logics, logical blocks, modules, and circuits described in connection with the aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, one or more hardware modules, or any suitable combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other suitable configuration. Additionally, at least one processor can comprise one or more modules operable to perform one or more of the operations or actions described herein.

Moreover, various aspects or features described herein can be implemented as a method, apparatus, or article of manufacture using standard programming or engineering techniques. Further, the operations or actions of a method or algorithm described in connection with the aspects disclosed herein can be embodied directly in a hardware module, in a software module executed by a processor, or in a combination of the two. Additionally, in some aspects, the operations or actions of a method or algorithm can reside as at least one or any combination or set of codes or computer readable instructions on a machine-readable medium or computer readable medium, which can be incorporated into a computer program product. Further, the term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally, various storage media described herein can represent one or more devices or other machine-readable media for storing information. The term “machine-readable medium” can include, without being limited to, wireless channels and various other media capable of storing, containing, or carrying instruction, or data.

Furthermore, various aspects are described herein in connection with a mobile device. A mobile device can also be called a system, a subscriber unit, a subscriber station, mobile station, mobile, mobile device, cellular device, multi-mode device, remote station, remote terminal, access terminal, user terminal, user agent, a user device, or user equipment, or the like. A subscriber station can be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device.

In addition to the foregoing, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. Furthermore, as used in this application and the appended claims, the term “or” is intended to mean an inclusive “or” rather than an exclusive “or.” That is, unless specified otherwise, or clear from context, “X employs A or B” is intended to mean any of the natural inclusive permutations. That is, in this example, X could employ A, or X could employ B, or X could employ both A and B, and thus the statement “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or deducing states of a system, environment, or user from a set of observations as captured via events or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events or data. Such inference results in the construction of new events or actions from a set of observed events or stored event data, whether or not the events are correlated in close temporal proximity, and whether the events and data come from one or several event and data sources.

Variations, modification, and other implementations of what is described herein will occur to those of ordinary skill in the art without departing from the spirit and scope of the disclosure as claimed. Accordingly, the disclosure is to be defined not by the preceding illustrative description but instead by the spirit and scope of the following claims.

What is claimed is:

1. A method for recommending content to a user, comprising:
employing a processor executing computer executable instructions stored on a computer readable storage medium to implement the following acts:
accessing a set of interaction queries, each query associated with a decision association and a presentation instruction;
presenting an interaction query from the set of interaction queries via a mobile user interface in accordance with the presentation instruction;
determining a first characteristic of a user of the mobile user interface based upon a response to the interaction query; and
presenting a plurality of content objects for user interaction comprising a first object that is selected to correspond to the first characteristic and a second object that is selected to solicit information regarding a second characteristic, wherein the second characteristic comprises a desired characteristic to be known about the user.

2. The method of claim 1, wherein the set of interaction queries comprises at least a portion of a question pattern having keystone queries, configured to obtain user characteristics including the first characteristic and the second characteristic, and entertaining queries, configured to engage the user.

3. The method of claim 1, wherein the set of interaction queries is derived from a lookup table that correlates a plurality of available interaction queries to interaction query response data from a plurality of user profiles.

4. The method of claim 1, further comprising updating a user profile of the user based upon a user interaction with the second object.

5. The method of claim 4, further comprising receiving one of an explicit affirmation input or an explicit discarding input for the second object.

6. The method of claim 4, further comprising receiving a preference input for the second object relative to the first object.

7. The method of claim 1, further comprising generating the set of interaction queries based in part upon a stored profile for the user.

8. The method of claim 1, further comprising subsequently presenting a third object based upon the first and second characteristics in response to a user specified time interval.

9. The method of claim 1, further comprising subsequently presenting a third object based upon the first and second characteristics in response to determining a new availability of the third object.

10. The method of claim 1, wherein the presenting of the plurality of content objects is based on the decision association providing a link to at least one of the first object or the second object based on the response to the interaction query.

11. The method of claim 1, wherein the presenting of the plurality of content objects further comprises presenting a second interaction query from the set of interaction queries, wherein the second interaction query comprises an attribute corresponding to the second characteristic.

12. The method of claim 1, wherein the presenting of the plurality of content objects further comprises presenting a second interaction query from the set of interaction queries, wherein the second interaction query comprises a first priority greater than a second priority of at least one other one of the set of interaction queries.

13. The method of claim 12, further comprising determining the first priority based on at least two of a user value for an attribute corresponding to the second characteristic, an operator value for the attribute, or a confidence level for the attribute.

14. A computer program product for recommending content to a user, comprising:
at least one computer readable storage medium storing computer executable instructions comprising:
at least one instruction executable by a processor accessing a set of interaction queries, each query associated with a decision association and a presentation instruction;
at least one instruction executable by the processor for presenting an interaction query from the set of interaction queries via a mobile user interface in accordance with the presentation instruction;
at least one instruction executable by the processor for determining a first characteristic of a user of the mobile user interface based upon a response to the interaction query; and
at least one instruction executable by the processor for presenting a plurality of content objects for user interaction comprising a first object that is selected to correspond to the first characteristic and a second object that is selected to solicit information regarding a second characteristic, wherein the second characteristic comprises a desired characteristic to be known about the user.

15. An apparatus for recommending content to a user, comprising:
means for accessing a set of interaction queries, each query associated with a decision association and a presentation instruction;
means for presenting an interaction query from the set of interaction queries via a mobile user interface in accordance with the presentation instruction;
means for determining a first characteristic of a user of the mobile user interface based upon a response to the interaction query; and
means for presenting a plurality of content objects for user interaction comprising a first object that is selected to correspond to the first characteristic and a second object that is selected to solicit information regarding a second characteristic, wherein the second characteristic comprises a desired characteristic to be known about the user.

16. An apparatus for recommending content to a user, comprising:
a computing platform for accessing a set of interaction queries, each query associated with a decision association and a presentation instruction; and
a user interface for presenting an interaction query from the set of interaction queries in accordance with the presentation instruction,
the computing platform further for determining a first characteristic of a user of the mobile user interface based upon a response to the interaction query, and
the user interface further for presenting a plurality of content objects for user interaction comprising a first object that is selected to correspond to the first characteristic and a second object that is selected to solicit information regarding a second characteristic, wherein the second characteristic comprises a desired characteristic to be known about the user.

17. The apparatus of claim 16, wherein the set of interaction queries comprises at least a portion of a question pattern having keystone queries, configured to obtain user characteristics including the first characteristic and the second characteristic, and entertaining queries, configured to engage the user.

18. The apparatus of claim 16, wherein the set of interaction queries is derived from a lookup table that correlates a plurality of available interaction queries to interaction query response data from a plurality of user profiles.

19. The apparatus of claim 16, wherein the computing platform is further for updating the user profile based upon a user interaction with the second object.

20. The apparatus of claim 19, wherein the user interface is further for receiving one of an explicit affirmation or an explicit discarding input for the second object.

21. The apparatus of claim 19, wherein the user interface is further for receiving a preference input for the second object relative to the first object.

22. The apparatus of claim 16, further comprising generating the set of interaction queries based in part upon a stored profile for the user.

23. The apparatus of claim 16, wherein the user interface is further for subsequently presenting a third object based upon the first and second characteristics in response to a user specified time interval.

24. The apparatus of claim 16, wherein the user interface is further for subsequently presenting a third object based upon the first and second characteristics in response to a determining a new availability of the third object.

25. The apparatus of claim 16, wherein the user interface is further for presenting the plurality of content objects based on the decision association providing a link to at least one of the first object or the second object based on the response to the interaction query.

26. The apparatus of claim 16, wherein the user interface is further for presenting the plurality of content objects comprising presenting a second interaction query from the set of interaction queries, wherein the second interaction query comprises an attribute corresponding to the second characteristic.

27. The apparatus of claim 16, wherein the user interface is further for presenting of the plurality of content objects comprising presenting a second interaction query from the set of interaction queries, wherein the second interaction query comprises a first priority greater than a second priority of at least one other one of the set of interaction queries.

28. The apparatus of claim 27, further comprising determining the first priority based on at least two of a user value for an attribute corresponding to the second characteristic, an operator value for the attribute, or a confidence level for the attribute.

29. A method for recommending content to a user, comprising:
employing a processor executing computer executable instructions stored on a computer readable storage medium to implement following acts:
provisioning a mobile device with a set of interaction queries, each query from the set of interaction queries associated with a decision association and a presentation instruction;
receiving a report from the mobile device that indicates a response of a user to the at least one of the set of interaction queries that was presented in accordance with the presentation instruction;
determining a first characteristic of the user based upon the response to the interaction query;
updating a user profile based upon the first characteristic; and
transmitting a plurality of content objects to the mobile device for user interaction comprising a first object that is selected to correspond to the first characteristic and a second object that is selected to solicit information regarding a second characteristic, wherein the second characteristic comprises a desired characteristic to be known about the user.

30. The method of claim 29, wherein the set of interaction queries comprises at least a portion of a question pattern having keystone queries, configured to obtain user characteristics including the first characteristic and the second characteristic, and entertaining queries, configured to engage the user.

31. The method of claim 29, wherein the set of interaction queries is derived from a lookup table that correlates a plurality of available interaction queries to interaction query response data from a plurality of user profiles.

32. The method of claim 29, further comprising updating the user profile of the user based upon a user interaction with the second object.

33. The method of claim 32, further comprising receiving one of an explicit affirmation input or an explicit discarding input for the second object.

34. The method of claim 32, further comprising receiving a preference input for the second object relative to the first object.

35. The method of claim 29, further comprising generating the set of interaction queries based in part upon a stored profile for the user.

36. The method of claim 29, wherein transmitting the plurality of content objects further comprises transmitting a third object based upon the first and second characteristics in response to a user specified time interval.

37. The method of claim 29, wherein transmitting the plurality of content objects further comprises transmitting a third object based upon the first and second characteristics in response to determining a new availability of the third object.

38. The method of claim 29, wherein the transmitting of the plurality of content objects is based on the decision association providing a link to at least one of the first object or the second object based on the response to the interaction query.

39. The method of claim 29, wherein the transmitting of the plurality of content objects further comprises transmitting a second interaction query from the set of interaction queries, wherein the second interaction query comprises an attribute corresponding to the second characteristic.

40. The method of claim 29, wherein the transmitting of the plurality of content objects further comprises transmitting a second interaction query from the set of interaction queries, wherein the second interaction query comprises a first priority greater than a second priority of at least one other one of the set of interaction queries.

41. The method of claim 40, further comprising determining the first priority based on at least two of a user value for an attribute corresponding to the second characteristic, an operator value for the attribute, or a confidence level for the attribute.

42. A computer program product for recommending content to a user, comprising:
at least one computer readable storage medium storing computer executable instructions comprising:
at least one instruction executable by a processor for provisioning a mobile device with a set of interaction queries, each query from the set of interaction queries associated with a decision association and a presentation instruction;
at least one instruction executable by the processor for receiving a report from the mobile device that indicates a user input to the at least one of the set of interaction queries that was presented in accordance with the presentation instruction;
at least one instruction executable by the processor for determining a first characteristic of a user of the mobile user interface based upon a response to the interaction query;
at least one instruction executable by the processor for updating a user profile based upon the first characteristic; and
at least one instruction executable by the processor for transmitting a plurality of content objects to the mobile device for user interaction comprising a first object that is selected to correspond to the first characteristic and a second object that is selected to solicit information regarding a second characteristic, wherein the second characteristic comprises a desired characteristic to be known about the user.

43. An apparatus for recommending content to a user, comprising:
means for provisioning a mobile device with a set of interaction queries, each query from the set of interaction queries associated with a decision association and a presentation instruction;
means for receiving a report from the mobile device that indicates a user input to the at least one of the set of interaction queries that was presented in accordance with the presentation instruction;
means for determining a first characteristic of a user of the mobile user interface based upon a response to the interaction query;
means for updating a user profile based upon the first characteristic; and
means for transmitting a plurality of content objects to the mobile device for user interaction comprising a first object that is selected to correspond to the first characteristic and a second object that is selected to solicit information regarding a second characteristic, wherein the second characteristic comprises a desired characteristic to be known about the user.

44. An apparatus for recommending content to a user, comprising:
a transmitter for provisioning a mobile device with a set of interaction queries, each query from the set of interaction queries associated with a decision association and a presentation instruction;
a receiver for receiving a report from the mobile device that indicates a response by a user to the at least one of the set of interaction queries that was presented in accordance with the presentation instruction; and
a computing platform for determining a first characteristic of the user based upon the response to the interaction query and for updating a user profile based upon the first characteristic,
the transmitter further for transmitting a plurality of content objects to the mobile device for user interaction comprising a first object that is selected to correspond to the first characteristic and comprising a second object that is selected to solicit information regarding a second characteristic, wherein the second characteristic comprises a desired characteristic to be known about the user.

45. The apparatus of claim 44, wherein the set of interaction queries comprises at least a portion of a question pattern having keystone queries, configured to obtain user characteristics including the first characteristic and the second characteristic, and entertaining queries, configured to engage the user.

46. The apparatus of claim 44, wherein the set of interaction queries is derived from a lookup table that correlates a plurality of available interaction queries to interaction query response data from a plurality of user profiles.

47. The apparatus of claim 44, wherein the computer platform is further operable for updating the user profile of the user based upon a user interaction with the second object.

48. The apparatus of claim 47, wherein the receiver is further operable for receiving one of an explicit affirmation input or an explicit discarding input for the second object.

49. The apparatus of claim 47, wherein the receiver is further operable for receiving a preference input for the second object relative to the first object.

50. The apparatus of claim 44, wherein the computer platform is further operable for generating the set of interaction queries based in part upon a stored profile for the user.

51. The apparatus of claim 44, wherein the plurality of content objects further comprises a third object based upon the first and second characteristics in response to a user specified time interval.

52. The apparatus of claim 44, wherein the plurality of content objects further comprises a third object based upon the first and second characteristics that is transmitted in response to determining a new availability of the third object.

53. The apparatus of claim 44, wherein the plurality of content objects is transmitted based on the decision association providing a link to at least one of the first object or the second object based on the response to the interaction query.

54. The apparatus of claim 44, wherein the plurality of content objects comprises a second interaction query from the set of interaction queries, wherein the second interaction query comprises an attribute corresponding to the second characteristic.

55. The apparatus of claim 44, wherein the plurality of content objects further comprises a second interaction query from the set of interaction queries, wherein the second interaction query comprises a first priority greater than a second priority of at least one other one of the set of interaction queries.

56. The apparatus of claim 55, wherein the computer platform is further operable to determine the first priority based on at least two of a user value for an attribute corresponding to the second characteristic, an operator value for the attribute, or a confidence level for the attribute.
